(19) United States
(12) Patent Application Publication
(10) Pub. No.: US 2015/0149375 A1
(43) Pub. Date: May 28, 2015

(54) CROWD ENDORSEMENT SYSTEM

(71) Applicant: Proteus Digital Health, Inc., Redwood City, CA (US)

(72) Inventors: Andrew Thompson, Portola Valley, CA (US); Todd Thompson, San Jose, CA (US)

(21) Appl. No.: 14/550,453

(22) Filed: Nov. 21, 2014

Related U.S. Application Data
(60) Provisional application No. 61/907,957, filed on Nov. 22, 2013.

(51) Int. Cl. G06Q 30/02; G06Q 50/00

(52) U.S. Cl. CPC G06Q 30/0279; G06Q 50/01
USPC 705/319; 705/329

(57) ABSTRACT

In one aspect, this disclosure provides a crowd endorsement social engine for endorsing an athlete. In various aspects crowd endorsement of athletes includes income and training support for semi-pro, amateur, Olympic athletes, sponsorship from family, friends, fans, and social community. In one aspect, individual athlete campaigns highlight goals, progress and achievement. In another aspect, athletes produce blog style updates on progress, physiologic tweets during competition in the form of broadcasting messages. In another aspect, sponsors create emotional attachment to their athlete and his/her success and provide encouragement. In another aspect, fans that attend events provide live updates to athletes' pages. In another aspect, community growth is based on athlete adoption and sponsor base.

### CROSS-REFERENCE TO RELATED APPLICATIONS

This application claims the benefit of U.S. Provisional Patent Application Ser. No. 61/907,957 entitled CROWD ENDORSEMENT SYSTEM, filed on Nov. 22, 2013, which is herein entirely incorporated by reference.

### INTRODUCTION

The present disclosure is related generally to a system and method for endorsing athletes. More particularly, the present disclosure is related to a system and method for endorsing athletes based at least in part on physiologic information.

On one side, there are many athletes, at the amateur or professional ranks, that have great talent and skills and potential but lack the resources to become elite members in their field of endeavor even after a few successful years. Other athletes have great hearts, but lack funding to improve their status as athletes. Still others simply do not have the resources to enter into competitive events. Some athletes may suffer harsh economic hardships if they are cut from a team, such as an Olympic team. For example, the U.S. Ski and Snowboard Association earlier this year cut the national ski champion Kris Freeman for the U.S. cross-country team, which cost him the chance to collect thousands of dollars in funding from the U.S. Olympic Committee, but also his USOC-subsidized health insurance. See The Skier Who Got The Cold Shoulder, Matthew Futterman, http://online.wsj.com/news/articles/SB1000142405270230450040, Updated Oct. 20, 2013 1:24 p.m. ET.

On the other side, there are many who are capable and willing to provide funding to those athletes with great talent, skills, potential, and hearts, but simply do not know where to begin. Then there are those who are willing to give, but do not have the financial resources to give, although they may have something else of value.

Although existing websites may be useful for posting information related to sponsors and athletes that need funding, such websites have limited capabilities and may be useful just for donating money without much recognition or promotion for the donor and without measuring the progress of the athlete. Therefore, there is a need for a system and method for endorsing athletes and measuring and tracking performance, injury, and recovery of an athlete. There is a need also for a system and method for analyzing results combined with data to provide a quicker path to an optimized formula based on the athlete's body. In addition, there is a need to measure and track the athlete's to provide opportunities for sponsors to work with certain athletes or for athletes to work with other athletes.

### SUMMARY

In one aspect, this disclosure provides a crowd endorsement social engine for endorsing an athlete. In various aspects crowd endorsement of athletes includes income and training support for semi-pro, amateur, Olympic athletes, sponsorship from family, friends, fans, and social community. In one aspect, individual athlete campaigns highlight goals, progress and achievement. In another aspect, athletes produce blog style updates on progress, physiologic tweets during competition in the form of broadcasting short burst bio-language messages. In another aspect, sponsors create emotional attachment to their athlete and his/her success and provide encouragement. In another aspect, fans that attend events provide live updates to athletes pages. In another aspect, community growth is based on athlete adoption and sponsor base.

In one aspect, the crowd endorsement social engine measures and tracks the performance of an athlete and recovery to guide training plans and loads. The crowd endorsement social engine also provides analysis of event results combined with pre-event data to provide a quicker path to an optimized formula based on the athlete's body. The athlete's success will provide opportunities to work with other athletes and with the crowd sponsor community

### FIGURES

FIG. 1 illustrates one aspect of a crowd endorsement system.

FIG. 2 illustrates an example crowd endorsement social media network environment associated with a crowd endorsement system.

FIG. 3 illustrates a subject using a mobile device comprising electrodes for detecting personal electrical signals from the body of the subject and providing haptic feedback to the subject.

FIG. 4 illustrates one aspect of a mobile device comprising electrodes for detecting electrical signals that can be employed to authenticate the identity of the subject to enable the subject to get access to the mobile device and providing haptic feedback to the subject.

FIG. 5 is system diagram of one aspect of a mobile device configured to detect electrical signals for authenticating the identity of the subject and provide haptic feedback to the subject.

FIG. 6 is a block functional diagram of one aspect of an authentication subsystem for detecting and/or generating a transconductance signal to confirm the identity of a person.

FIG. 7 is a block diagram representation of one aspect of the event indicator system with dissimilar metals positioned on opposite ends.

FIG. 8 is a block diagram representation of another aspect of the event indicator system with dissimilar metals positioned on the same end and separated by a non-conducting material.

FIG. 9 shows ionic transfer or the current path through a conducting fluid when the event indicator system of FIG. 9 is in contact with conducting liquid and in an active state.

FIG. 9A shows an exploded view of the surface of dissimilar materials of FIG. 9.

FIG. 9B shows the event indicator system of FIG. 9 with a pH sensor unit.

FIG. 10 is a block diagram illustration of one aspect of the control device used in the system of FIGS. 7 and 8.

FIG. 11 is a functional block diagram of a demodulation circuit that performs coherent demodulation that may be present in a receiver, according to one aspect.

FIG. 12 illustrates a functional block diagram for a beacon module within a receiver, according to one aspect.

FIG. 13 is a block diagram of the different functional modules that may be present in a receiver, according to one aspect.

FIG. 14 is a block diagram of a receiver, according to one aspect.

FIG. 15 provides a block diagram of a high frequency signal chain in a receiver, according to one aspect.

FIG. 16 provides a diagram of how a system that includes a signal receiver and an ingestible event marker may be employed, according to one aspect.

FIG. 17 is a diagram of a communication system based at least in part on broadcasting short burst bio-language messages based on physiologic information for use with a crowd endorsement system.

FIG. 18 is a diagram of a crowd endorsement system.

FIG. 18A is a detail view of the donations portion of the crowd endorsement system diagram shown in FIG. 18.

FIG. 18B is a detail view of the applications and expert panel celebrity judges aspects of the crowd endorsement system diagram shown in FIG. 18.

FIG. 18C is a detail view of the progression, subscription process, and NCAA amateur athlete aspects of the crowd endorsement system diagram shown in FIG. 18.

FIG. 18D is a detail view of the amateur athletes, professional athletes, and social media integration aspects of the crowd endorsement system diagram shown in FIG. 18.

FIG. 18E is a detail view of the governance, third party management, and sponsors aspects of the crowd endorsement system diagram shown in FIG. 18.

FIG. 19 is a diagram of a crowd endorsement system.

### DESCRIPTION

Before explaining the various aspects of a crowd endorsement system based on physiologic information in detail, it should be noted that the various aspects disclosed herein are not limited in their application or use to the details of construction and arrangement of parts illustrated in the accompanying drawings and description. Rather, any disclosed aspect of the crowd endorsement system based on physiologic information may be positioned or incorporated in other aspects, variations, and modifications thereof, and may be practiced or carried out in various ways. Accordingly, aspects of the crowd endorsement system based on physiologic information disclosed herein are illustrative in nature and are not meant to limit the scope or application thereof. Furthermore, unless otherwise indicated, the terms and expressions employed herein have been chosen for the purpose of describing the aspects for the convenience of the reader and are not to limit the scope thereof. In addition, it should be understood that any one or more of the disclosed aspects, expressions of aspects, and/or examples thereof, can be combined with any one or more of the other disclosed aspects, expressions of aspects, and/or examples thereof, without limitation.

In the following description, like reference characters designate like or corresponding parts throughout the several views. Also, in the following description, it is to be understood that terms such as front, back, inside, outside, top, bottom and the like are words of convenience and are not to be construed as limiting terms. Terminology used herein is not meant to be limiting insofar as devices described herein, or portions thereof, may be attached or utilized in other orientations. The various aspects will be described in more detail with reference to the drawings.

It will be appreciated that the term “medication” or “dose form” as used throughout this disclosure includes various forms of ingestible, inhalable, injectable, absorbable, or otherwise consumable medicaments and/or carriers therefor such as, for example, pills, capsules, gel caps, placebos, over capsulation carriers or vehicles, herbal, over-the-counter (OTC) substances, supplements, prescription-only medication, ingestible event markers (IEM), and the like.

In one aspect, the present specification provides a body-associated personal wearable communication devices (“body-associated personal communicator”). In one aspect, the body-associated personal communicator is in communication with a living subject. In one aspect, the body-associated personal communicator is in communication with a local node external to the body of the living subject. In one aspect, the local node is in communication with a remote node via a network and, accordingly, the living subject is able to communicate with the remote node. Information also may be communicated from the remote node and/or the local node to the living subject via the body-associated personal communicator. In various aspects, the two-way communication between the living subject and the body-associated personal communicator occurs discreetly such that the communications are non-detectable by humans other than the subject. Such discreet mode of communication minimizes the intrusiveness into the living subject's sense of privacy and enhances the likelihood that the living subject will accept the personal communicator and use it in a prescribed manner.

In another aspect, the present specification provides a body-associated personal communicator that senses personal physiologic parameters of the living subject and communicates such parameters to the local node and in some aspects to the remote node. Information associated with the personal physiologic parameters also may be communicated from the remote node and/or the local node to the living subject via the body-associated personal communicator. As described above, communications between the individual and the body-associated personal communicator occurs discreetly to enhance the likelihood of acceptance of the body-associated personal communicator by the living subject.

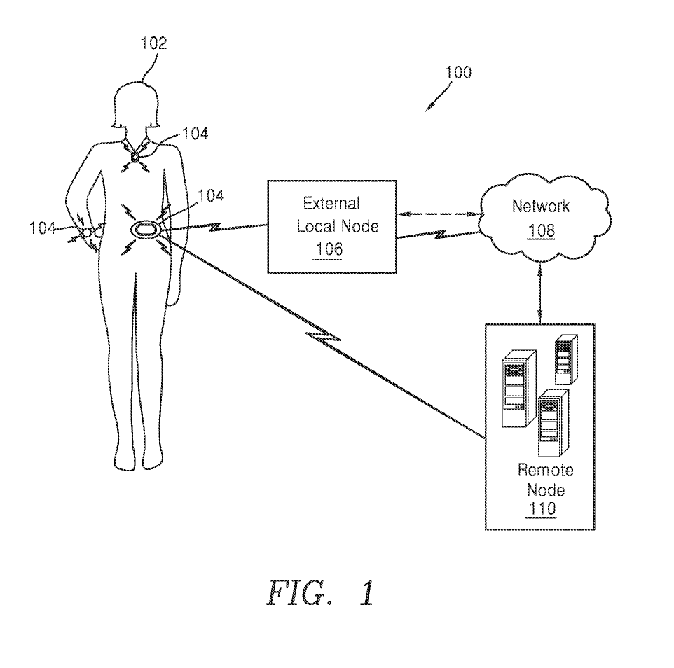

FIG. 1 illustrates one aspect of a social media personal communication system 100. As illustrated in FIG. 1, a receiver, otherwise referred to herein as a body-associated personal communicator 104, is positioned on a living subject 102. The living subject 102 may be a human or non-human being. In various aspects, the body-associated personal communicator 104 may be realized in many forms and configurations including sensor-enabled patches, watches, and jewelry, as shown in FIG. 1, for example, as well as a bandage with an adhesive portion, wristbands, earrings, bracelets, rings, pendants, clothing, undergarments, hats, caps, scarves, pins, accessories, belts, shoes, eyeglasses, contact lenses, hearing-aides, subcutaneous implants, and other devices that are wearable, implantable, or semi-implantable on or in the living subject 102 without limitation. The body-associated personal communicator 104 is configured to communicate with the living subject 102 and an external local node 106. The external local node 106 is configured to communicate with a remote node 110 via a network 108. In one aspect, the body-associated personal communicator 104 is configured to communicate with the remote node 110 directly. It will be appreciated that in the context of the present disclosure, communication is intended to encompass communications to and from the personal communicator 104 and the external local node 106. Likewise, communication is intended to encompass communications to and from the body-associated personal communicator 104 and the remote node 110 as well as communications to and from the external local node 106 and the remote node 110. It will also be appreciated that the body-associated personal communicator 104 may communicate to the subject 102 as well as receive information from the subject 102. As described in more detail below, information from the subject 102 may be obtained via one or more sensors, electrodes, ingestible event markers (IEM) as defined herein, and inputs from the subject 102 such as voice, haptic, vibratory, pushbutton, touchscreen, among other techniques described herein.

The body-associated personal communicator 104 may comprise any number of distinct physiologic parameter or biomarker collecting and/or sensing capabilities. The number of distinct parameters or biomarker collecting and/or sensing capabilities may vary e.g., one or more, two or more, three or more, four or more, five or more, ten or more, and so on. In certain configurations, the body-associated personal communicator 104 comprises one or more active components that are able to dynamically monitor and record individual physiologic parameters and/or biomarkers associated with the living subject 102. Such components include, without limitation, sensors, electronic recording devices, processors, memory, communication components. In one aspect, the body-associated personal communicator 104 may include an on-board battery to supply electrical power to the active components. The physiologic parameter or biomarker sensing abilities may include sensing cardio-data, including heart rate, electrocardiogram (ECG), and the like, respiration rate, temperature, pressure, chemical composition of fluid, e.g., analyte in blood, fluid state, blood flow rate, physical activity, sleep, accelerometer motion data, without limitation, for example.

In one aspect, the body-associated personal communicator 104 provides specific information about the physiologic state of the subject 102. In another aspect, some of this information may be derived from sensors embedded in the body-associated personal communicator 104. The subject 102 may obtain the body-associated personal communicator 104 with a prescription, for example, and then wear the body-associated personal communicator 104 for a prescribed period, e.g., hours, days, weeks, months, years.

In one aspect, the body-associated personal communicator 104 includes, is configured to (a) monitor and record individual physiology, e.g., physical activity, heart rate, respiration, temperature, sleep, fluidics information, etc., of the living subject 102 and (b) communicate these parameters beyond the body of the living subject 102 to other client devices, e.g., mobile phones, computers, internet servers, etc., in order to (c) enable support and collaboration for fitness, wellbeing, disease management, sport, entertainment, gaming, social goals, and other applications on a social media platform. A challenge for such body-associated personal communicators 104 is creating a compelling rationale for the individual 102 to wear or use the body-associated personal communicator 104 on a continuous basis—for example, to apply an adhesive bandage-based body-associated personal communicator 104 to their skin for weeks, months and potentially years and accept the possibility of its inconveniences and limitations, such as (i) potential skin irritation, (ii) the burden of frequent application and removal, and (iii) a feeling of intrusiveness into the wearer's daily life. An opportunity for the personal communicator 104 is to exploit fundamental “intimacy” advantages they have over other sensor-enabled and communication devices that are not worn on or in the body—a body-associated personal communicator 104 interface with the individual 102 is by definition highly personal and tangible, with the ability to have private, communication between the individual and the personal communicator (leveraging physical, tactile “body language” or other signals), where the communication is substantially undetectable by others. In this manner, the body-associated personal communicator 104 may enable product and service possibilities not feasible with other approaches. The body language opportunity seeks to overcome at least some of the challenges and burdens of the body-associated personal communicator 104 to create a compelling rationale to make the body-associated personal communicator 104 as indispensable to a consumer as the mobile phone as an extension of their mind and body. In one aspect, discreet communications between the body-associated personal communicator 104 and the living subject 102 can be auditory via a small earpiece placed inside the ear canal, or visual via images projected on specialized eye glasses worn by living subject 102. In other aspects, discreet modes of communication between the living subject 102 and the personal communicator 104 include, without limitation, visual, auditory, vibratory, tactile, olfactory, and taste as described in the form of illustrative examples hereinbelow.

In one aspect, the body-associated personal communicator 104, for example a sensor patch that adheres to the skin of an individual such as the living subject 102, communicates with its wearer by sending and receiving tactile, haptic, or other signals. The default settings may be modified such that the body-associated personal communicator 104 discreetly vibrates or pulses in a specific manner or pattern, e.g., time or space based, to remind the subject 102 of important events or to communicate important personalized messages to the wearer. The default settings also may be modified such that the subject 102 can transmit and record meaningful inputs and messages to the body-associated personal communicator 104 by communicating a simple language of finger taps, jiggles, scratches or other physical inputs initiated by the subject 102. Through the body-associated personal communicator 104 communications architecture, e.g., a BLUETOOTH™ or other communication links to other devices beyond the body, the composite set of sensed physiology, tactile inputs, and outputs can be transmitted to other individuals, groups, caregivers, and related products, e.g., online games, of the subject's 102 choosing via the external local node 106, network 108, and/or the remote node 110. The features of the body-associated personal communicator 104 are based on a sustained behavior change mechanism and it increases the value and potential of body-associated personal communicators 104 and the likelihood that consumers will seek out, use, and benefit from such body-associated personal communicators 104.

In-body communications include any communication of data or information via the body of the living subject 102, i.e., communication via or associated with inter-body aspects, intra-body aspects, and a combination of the same. For example, inter-body aspects include communications associated with devices designed to attach to a body surface. Intra-body aspects include communications associated with data generated from within the body, e.g., by the body itself or by a device implanted, ingested, or otherwise locatable in, or partially in, the body. For example, intra-body communications are disclosed in the U.S. Provisional Patent Application No. 61/251,088, the entire content of which is hereby incorporated by reference.

Communications include and/or may be associated with software, hardware, circuitry, various devices, and combinations thereof.

The devices include devices associated with physiologic data generation, transmission, reception, communication. The devices further include various implantable, ingestible, insertable, and/or attachable devices associated with the human body or other living organisms. The devices still further include multimedia devices such as telephones, stereos, audio players, PDAs, handheld devices, and multimedia players.

The system for incorporating physiologic data enables exchange, transmission, receipt, manipulation, management, storage, and other activities and events related to physiologic data. Such activities and events may be contained within the system for incorporating physiologic data, partially integrated with the system for incorporating physiologic data, or associated with externalities, e.g., activities, systems, components, and the like which are external to the system for incorporating physiologic data.

The physiologic data environment includes any source of information or data, including remote computer systems, local computer devices. The information or data may comprise physiologic data in whole or in part, e.g., aggregated or generated with other types of data. The physiologic data may be pure or refined, e.g., physiologic data from which inferences are drawn.

As shown in FIG. 1, the body-associated personal communicator 104, regardless of form factor or implementation is in communication with an external local node 106. In one aspect, the body-associated personal communicator 104 includes the capability of communicating, e.g., receiving, transmitting, generating, and recording data directly or indirectly from the living subject 102. Although the data may include physiologic data, it is not limited as such. Any data of a physiologic nature may be associated with the living subject 102. The physiologic data may include, for example, heart rate, heart rate variability, respiration rate, body temperature, temperature of local environment, three-axis measurement of activity and torso angle, as well as other physiologic data, metrics, inertial measurements comprising at least an accelerometer, a gyroscope, and a magnetometer, and indicators associated with one or more individuals. The physiologic data may be communicated at various times or time intervals to the external local node 106. For example, the communication may be real-time, i.e., in close temporal proximity to a time in which the physiologic data were generated, measured, ascertained, or on an historical basis, i.e., in far temporal proximity to a time in which the physiologic data was generated, measured, ascertained. In various aspects, the physiologic data may be associated with a variety of devices, e.g., cardiac device.

In one aspect, the external local node 106 may be configured as a communication hub and may include any hardware device, software, and/or communications component(s), as well as systems, subsystems, and combinations of the same which generally function to communicate physiologic and non-physiologic data between the personal communicator 104 and the external local node 106. Communication of the data includes receiving, storing, manipulating, displaying, processing, and/or transmitting the data to the remote node 110 via the network 108.

In various aspects, the external local node 106 also functions to communicate, e.g., receive and transmit, non-physiologic data. Example of non-physiologic data include gaming rules and data generated by a separate cardiac-related device such as an implanted pacemaker and communicated to the hub directly or indirectly, e.g., via the personal communicator 104.

Broad categories of external local nodes 106 include, for example, base stations, personal communication devices, handheld devices, and mobile telephones. In various aspects, the external local node 106 may be implemented as a handheld portable device, computer, mobile telephone, sometimes referred to as a smartphone, tablet personal computer (PC), kiosk, desktop computer, laptop computer, game console, or any combination thereof. Although some aspects of the external local node 106 may be described with a mobile or fixed computing device implemented as a smart phone, personal digital assistant, laptop, desktop computer by way of example, it may be appreciated that the various aspects are not limited in this context. For example, a mobile computing device may comprise, or be implemented as, any type of wireless device, mobile station, or portable computing device with a self-contained power source, e.g., battery, such as the laptop computer, ultra-laptop computer, personal digital assistant (PDA), cellular telephone, combination cellular telephone/PDA, mobile unit, subscriber station, user terminal, portable computer, handheld computer, palmtop computer, wearable computer, media player, pager, messaging device, data communication device, and so forth. A fixed computing device, for example, may be implemented as a desk top computer, workstation, client/server computer, and so forth.

The external local node 106 comprises personal communication devices including, for example, devices having communication and computer functionality and typically intended for individual use, e.g., mobile computers, sometimes referred to as “handheld devices.” Base stations comprise any device or appliance capable of receiving data such as physiologic data. Examples include computers, such as desktop computers and laptop computers, and intelligent devices/appliances. Intelligent devices/appliances include consumer and home devices and appliances that are capable of receipt of data such as physiologic data. Intelligent devices/appliances may also perform other data-related functions, e.g., transmit, display, store, and/or process data. Examples of intelligent devices/appliances include refrigerators, weight scales, toilets, televisions, door frame activity monitors, bedside monitors, bed scales. Such devices and appliances may include additional functionality such as sensing or monitoring various physiologic data, e.g., weight, heart rate. Mobile telephones include telephonic communication devices associated with various mobile technologies, e.g., cellular networks.

In various aspects, the external local node 106 may provide voice and/or data communications functionality in accordance with different types of cellular radiotelephone systems. Examples of cellular radiotelephone systems may include Code Division Multiple Access (CDMA) systems, Global System for Mobile Communications (GSM) systems, North American Digital Cellular (NADC) systems, Time Division Multiple Access (TDMA) systems, Extended-TDMA (E-TDMA) systems, Narrowband Advanced Mobile Phone Service (NAMPS) systems, 3G systems such as Wide-band CDMA (WCDMA), CDMA-2000, Universal Mobile Telephone System (UMTS) systems, WiMAX (Worldwide Interoperability for Microwave Access, LTE (Long Term Evolution) and so forth.

In various embodiments, the external local node 106 may be configured to provide voice and/or data communications functionality in accordance with different types of wireless network systems or protocols. Examples of suitable wireless network systems offering data communication services may include the Institute of Electrical and Electronics Engineers (IEEE) 802.xx series of protocols, such as the IEEE 802.1a/b/g/n series of standard protocols and variants (also referred to as “WiFi”), the IEEE 802.16 series of standard protocols and variants (also referred to as “WiMAX”), the IEEE 802.20 series of standard protocols and variants, and so forth. A mobile computing device may also utilize different types of shorter range wireless systems, such as a Bluetooth system operating in accordance with the Bluetooth Special Interest Group (SIG) series of protocols, including Bluetooth Specification versions v1.0, v1.1, v1.2, v1.0, v2.0 with Enhanced Data Rate (EDR), as well as one or more Bluetooth Profiles, and so forth. Other examples may include systems using infrared techniques or near-field communication techniques and protocols, such as electromagnetic induction (EMI) techniques.

In one aspect, the external local node 106, for example, the hub, includes a software application associated with a mobile telephone of a patient. The application and mobile telephone function to receive physiologic data from a receiver, which, in turn, receives the physiologic data directly from an individual or indirectly, e.g., via a device. Examples of devices include cardiac devices and ingestible devices. The hub stores, manipulates, and/or forwards the data, alone or in combination with other data, via the network 108 to a remote node 110.

In various aspects, the external local node 106 (hub) receives, generates, communicates, and/or transmits, physiologic data, alone or in combination with other data, i.e., non-physiologic data such as ingestion information from IEMs or various sources. Communication from the external local node 106 includes any transmission means or carriers, and combinations thereof, including wireless, wired, RF, conductive, etc. as is known in the art or as may become available in the future.

In various aspects, the handheld device includes software, e.g., a software agent/application, associated with the physiologic data. In various aspects of the handheld device, the software is preconfigured, i.e., configurable by the manufacturer/retailer; configurable by the consumer, i.e., downloadable from a website; or a combination of the same.

The base station includes systems, subsystems, devices, and/or components that receive, transmit, and/or relay the physiologic data. In various aspects, the base station communicably interoperates with a receiver such as the body-associated personal communicator 104 and a communications network 108 such as the Internet. Examples of base stations are computers, e.g., servers, personal computers, desktop computers, laptop computers, intelligent devices/appliances, etc., as heretofore discussed.

In various aspects, the base station may be embodied as an integrated unit or as distributed components, e.g., a desktop computer and a mobile telephone in communication with one another and in communication with a patch receiver and the Internet.

In various aspects, the base station includes the functionality to wirelessly receive and/or wirelessly transmit data, e.g., physiologic data received from and transmitted to the body-associated personal communicator 104 and the Internet.

Further, in various aspects, the base station may incorporate and/or be associated with, e.g., communicate with, various devices. Such devices may generate, receive, and/or communicate data, e.g., physiologic data. The devices include, for example, “intelligent” devices such as gaming devices, e.g., electronic slot machines, handheld electronic games, electronic components associated with games and recreational activities.

The mobile telephone includes, for example, devices such as a short-range, portable electronic device used for mobile voice or data communication over a network of specialized cell site base stations. The mobile telephone is sometimes known as or referred to as “mobile,” “wireless,” “cellular phone,” “cell phone,” or “hand phone (HP).”

In addition to the standard voice function of a telephone, various aspects of mobile telephones may support many additional services and accessories such as short message service (SMS) for text messaging, email, packet switching for access to the Internet, Java gaming, wireless, e.g., short range data/voice communications, infrared, camera with video recorder, and multimedia messaging system (MMS) for sending and receiving photos and video. Some aspects of mobile telephones connect to a cellular network of base stations (cell sites), which is, in turn, interconnected to the public switched telephone network (PSTN) or satellite communications in the case of satellite phones. Various aspects of mobile telephones can connect to the Internet, at least a portion of which can be navigated using the mobile telephones.

In various aspects, the mobile telephone includes software, e.g., a software agent/application, associated with the physiologic data. One example is an auto refill application related to or integrated with an auto refill system to facilitate automated prescription refill functions. In various aspects of the mobile telephone, the software is preconfigured, i.e., configurable by the manufacturer/retailer; configurable by the consumer, i.e., downloadable from a website; or a combination of the same.

Further, various aspects of the hub include combinations of devices. One such combination is the body-associated personal communicator 104 in communication with the handheld device or the mobile telephone. Thus, for example, the body-associated personal communicator 104 wirelessly transmits physiologic data to the mobile telephone having a receiver and a software agent available thereon. The receiver of the mobile telephone receives the physiologic data. A software agent, e.g., an application, processes the physiologic data and displays various information related to the physiologic data via, for example, a customized graphical user interface (GUI). In various aspects, the software agent generates displays with a predetermined “look and feel,” i.e., recognizable to a user as belonging to a predetermined group of software programs, GUIs, source devices, communities, gaming software, etc.

More particularly, the personal communication system 100 includes any environment having therein, or associated with, data or communication of physiologic data for a gaming or recreational purpose. Communication includes any method, act, or vehicle of communication, and/or combinations thereof. For example, communication methods include manual, wired, and wireless. Wireless technologies include radio signals, such as x-rays, ultraviolet light, the visible spectrum, infrared, microwaves, and radio waves, etc. Wireless services include voice and messaging, handheld and other Internet-enabled devices, data networking.

Vehicles of communication include the network 108. In various aspects, the network 108 comprises local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments include in-body communications, various devices, various modes of communications such as wireless communications, wired communications, and combinations of the same.

Wireless communication modes include any mode of communication between points that utilizes, at least in part, wireless technology including various protocols and combinations of protocols associated with wireless transmission, data, and devices. The points include, for example, wireless devices such as wireless headsets, audio and multimedia devices and equipment, such as audio players and multimedia players, telephones, including mobile telephones and cordless telephones, and computers and computer-related devices and components, such as printers.

Wired communication modes include any mode of communication between points that utilizes wired technology including various protocols and combinations of protocols associated with wired transmission, data, and devices. The points include, for example, devices such as audio and multimedia devices and equipment, such as audio players and multimedia players, telephones, including mobile telephones and cordless telephones, and computers and computer-related devices and components, such as printers.

In one aspect, the remote node 110 comprises social network systems, commercial systems, healthcare systems, pharmacy systems, university systems, financial transaction systems, web communities, physician systems, family caregiver systems, regulatory agency systems, wholesaler/retailer systems as described in U.S. patent application Ser. No. 12/522,249 titled “INGESTIBLE EVENT MARKER DATA SYSTEM,” the disclosure of which is herein incorporated by reference in its entirety. In other aspects, the remote node 110 comprises state games, behavioral reflective games, psychological response games, synchronization games, actual progress games, and recreational games as described in PCT Patent Application No. PCT/US09/60713 dated Oct. 14, 2009 titled “METHOD AND SYSTEM FOR INCORPORATING PHYSIOLOGIC DATA IN A GAMING ENVIRONMENT” and published as WO 2010/045385, the disclosure of which is herein incorporated by reference in its entirety. Additional disclosure may be found in PCT/US2012/025061 dated Feb. 14, 2012 titled “WEARABLE PERSONAL COMMUNICATOR APPARATUS, SYSTEM, AND METHOD” and published as WO 2012/112561 A1, the disclosure of which is herein incorporated by reference in its entirety.

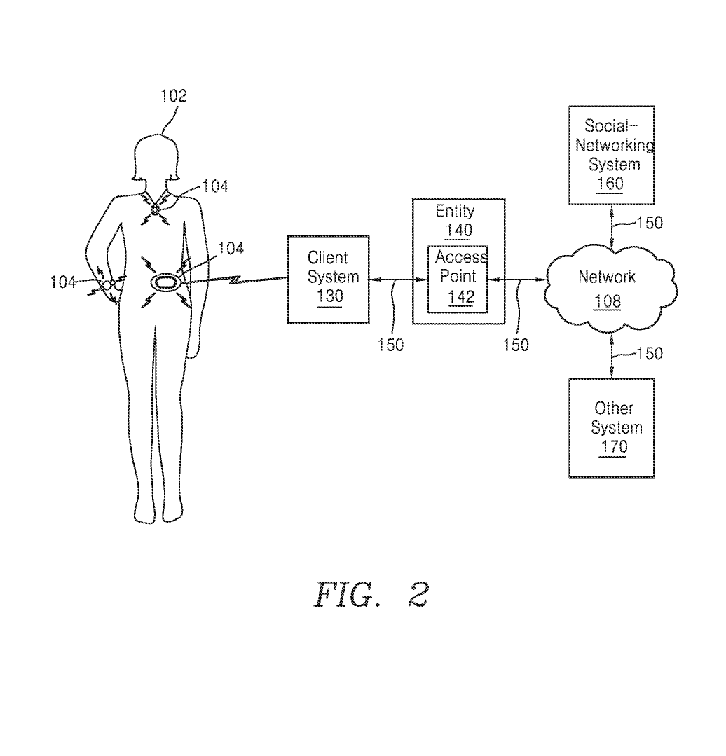

FIG. 2 illustrates an example social media network environment 101 associated with a social-networking system 160 and a short burst bio-language messaging communication system and a network access point 142. Network environment 101 includes a user 102 wearing a body-associated personal communicator 104, a client system 130, a wireless access point 142 of an entity 140, a social-networking system 160, and a third-party system 170 connected to each other by a network 108. In one aspect, the external local node 106 (FIG. 1) may be represented as client system 130 and wireless access point 142 and remote node 110 (FIG. 1) may be represented as social-networking system 160. Although FIG. 2 illustrates a particular arrangement of user 102 wearing a body-associated personal communicator 104, client system 130, wireless access point 142, social-networking system 160, third-party system 170, and network 108, this disclosure contemplates any suitable arrangement of user 101, client system 130, wireless access point 142, social-networking system 160, third-party system 170, and network 108. As an example and not by way of limitation, two or more of client system 130, wireless access point 142, social-networking system 160, and third-party system 170 may be connected to each other directly, bypassing network 108. As another example, two or more of client system 130, wireless access point 142, social-networking system 160, and third-party system 170 may be physically or logically co-located with each other in whole or in part. Moreover, although FIG. 2 illustrates a particular number of users 102 wearing a body-associated personal communicator 104, client systems 130, entities 140, wireless access points 142, social-networking systems 160, third-party systems 170, and networks 108, this disclosure contemplates any suitable number of users 102 each wearing a body-associated personal communicator 104, client systems 130, entities 140, wireless access points 142, social-networking systems 160, third-party systems 170, and networks 108. As an example and not by way of limitation, network environment 101 may include multiple users 102 each wearing a body-associated personal communicator 104, client systems 130, entities 140, wireless access points 142, social-networking systems 160, third-party systems 170, or networks 108. Various examples of social-networking applications employing a body-associated personal communicator 104 is described in U.S. Provisional Application No. 61/899,704, entitled “SOCIAL MEDIA NETWORKING BASED ON PHYSIOLOGIC INFORMATION,” filed Nov. 4, 2013, which is incorporated herein by reference in its entirety.

In particular embodiments, user 102 wearing a body-associated personal communicator 104 may be an individual (human user) or a group of individuals each wearing a body-associated personal communicator 104 that interacts or communicates with or over other elements of network environment 101 such as devices coupled to network 108 or social-networking system 160. In particular embodiments, one or more users 102 wearing a body-associated personal communicator 104 may use one or more client systems 130 to access, send data to, and receive data from network 108, social-networking system 160, or third-party system 170. Client system 130 may access network 108, social-networking system 160, or other system for e.g., third-party system 170 directly or via a third-party system or device. As an example and not by way of limitation, client system 130 may access third-party system 170 via social-networking system 160. In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130.

In particular embodiments, client system 130 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser to a particular server (such as a server coupled to network 108, or a server associated with social-networking system 160 or third-party system 170), and the web browser may generate a Hyper Text Transfer Protocol (HTTP) request and communicate the HTTP request to the server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

Entity 140 may represent any individual, business, or organization. Entity 140 may be associated with wireless access point 142. For example, entity 140 may own or control wireless access point 142. In particular embodiments, entity 140 is a merchant that offers free network access (e.g., to the Internet) to authorized customers via wireless access point 142. In other embodiments, entity 140 is an owner of a wireless access point 142 located at the residence or business of the owner. In particular embodiments, wireless access point 142 is operable to bridge or route data traffic between client system 130 and network 108. Wireless access point 142 may include a router, gateway, modem, a network switch, or other suitable device for providing network access to client systems 130. In particular embodiments, wireless access point 142 is capable of communicating with a plurality of client systems 130 via wired or wireless links 150. Wireless access point 142 is also capable of communicating with network 108 via link 150.

This disclosure contemplates any suitable network 108. As an example and not by way of limitation, one or more portions of network 108 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 108 may include one or more networks 108.

Links 150 may connect client system 130, wireless access point 142, social-networking system 160, and third-party system 170 to communication network 108 or to each other. This disclosure contemplates any suitable links 150. In particular embodiments, one or more links 150 include one or more wireline (such as for example Ethernet, Digital Subscriber Line (DSL), or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 101. One or more first links 150 may differ in one or more respects from one or more second links 150.

In particular embodiments, the access point 142 may communicate with social-networking system 160 to determine whether a user is authorized to use wireless access point 142. The social-networking system 160 may decide whether to allow a particular user based at least upon social-networking information associated with the user and may communicate this decision to wireless access point 142.

In particular embodiments, social-networking system 160 may be a network-addressable computing system hosting an online social network. Social-networking system 160 may generate, store, receive, and transmit social-networking data, such as, for example, user-physiologic data obtained from body-associated personal communicator 104, user-profile data, concept-profile data, social-graph information, or other suitable data related to the online social network. Social-networking system 160 may be accessed by the other components of network environment 100 either directly or via network 108.

Social-networking system 160 may provide users of the online social network the ability to communicate and interact with other users wearing a body-associated personal communicator 104. In particular embodiments, users wearing a body-associated personal communicator 104 may join the online social network via social-networking system 160 and then add connections (i.e., relationships) to a number of other users of social-networking system 160 wearing a body-associated personal communicator 104 whom they want to be connected to. Herein, the term “friend” may refer to any other user of social-networking system 160 with whom a user has formed a connection, association, or relationship via social-networking system 160. For purposes of the present disclosure, friends and relationships and groupings of friends are based at least in part on user physiologic data provided to the social-networking system 160 via body-associated personal communicator 104.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160. In particular embodiments, social-networking system 160 may include an authorization server that allows users 102 wearing a body-associated personal communicator 104 to opt in or opt out of having their actions logged by social-networking system 160 or shared with other systems (e.g., third-party systems 170), such as, for example, by setting appropriate privacy settings.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, body-associated personal communicator 104 communicates posts to social-networking system 160 from a client system 130. Posts may include physiologic information associated and/or ingestion information with the user as well as status updates, other textual data, location information, photos, videos, links, music or other similar data or media. Content may also be added to social-networking system 160 by a third-party through a “communication channel,” such as a newsfeed or stream.

In particular embodiments, social-networking system 160 may include one or more user-profile stores for storing user profiles based on information received from body-associated personal communicator 104. A user profile may include, for example, a user name and password, identifiers of client systems used by the user, biographic information, demographic information, behavioral information, social information, physiologic information, ingestpoin information, or other types of descriptive information, such as work experience, educational history, hobbies or preferences, interests, affinities, location, or physical activities. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Ad-pricing modules may combine social information, the current time, location information, or other suitable information to provide relevant advertisements, in the form of notifications, to a user.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet. Third-party system 170 may be accessed by the other components of network environment 101 either directly or via network 108.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

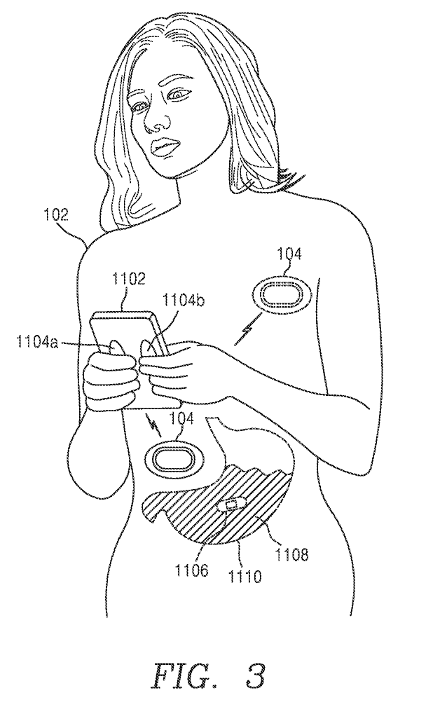

FIG. 3 describes one aspect of a system employing a sensing subsystem coupled to a subject, an event indicator system, and/or a body-associated personal communicator 104 by way of at least one electrode. A subject can be person or thing that is requesting access to the social-networking system. The body-associated personal communicator 104 and the event indicator system are configured to generate a unique electrical current signal that is detectable by a detection subsystem. In addition, the detection subsystem may be configured to detect various physiologic parameters associated with a living subject. The at least one electrode may be employed to detect physiologic signals from the subject as well as provide stimulus to the subject. In other words, the electrodes can be used as a two way communication interface between the subject and the event indicator system and/or a body-associated personal communicator 104 b

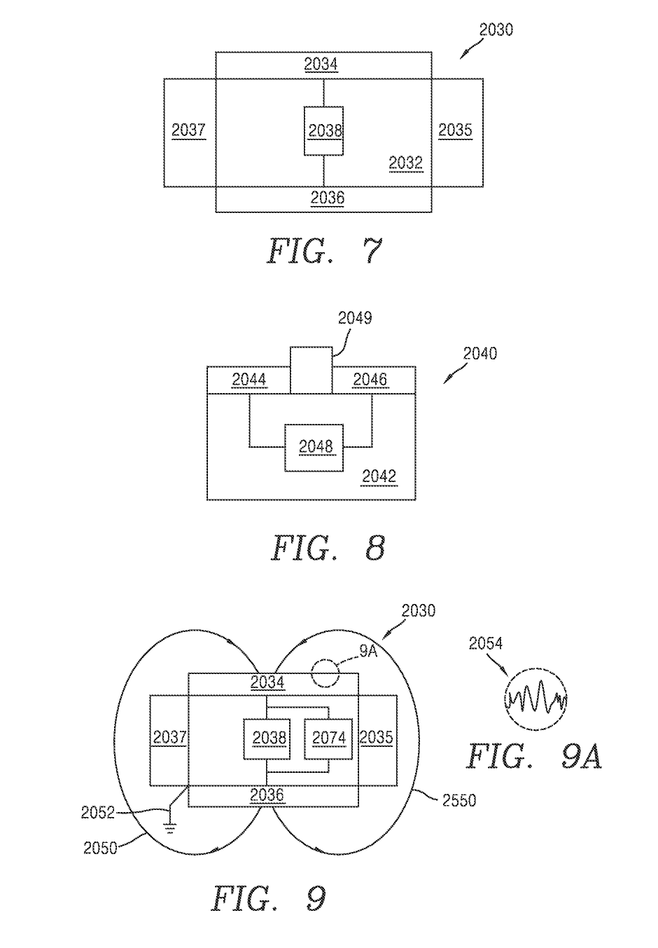

FIG. 3 illustrates a subject 102 using a mobile device 102 comprising electrodes 1104a, 1104b for detecting personal electrical signals conducted through the body of the subject 102 where such personal electrical signals represent physiologic data associated with the subject 102. In the illustrated example, the mobile device 1102 provides access to the social-networking system 160. The mobile device 1102 comprises electrodes 1104a, 1104b integrated into the housing for detecting electrical signals coupled from the subject 102 to the electrodes 1104a, 1104b. The term personal electrical signal is used to indicate that a signal is intimately associated with the subject 102 and can be used to confirm the identity of the subject 102 for purposes of authentication and provide physiologic information and/or ingestion information to the social-networking system 160. Personal electrical signals include, without limitation, physiologic signals associated with the subject, transbody conductive signals generated by an ingestible event marker system 1106, transbody conductive signals generated by a body-associated personal communicator 104, e.g., an adhesive patch that is applied on the body of the subject 102, any object in physical contact with the subject for example watch, bracelet, necklace, ring, etc. and/or transbody conductive signals generated by an implanted body-associated device 104 that is located within the body of the subject 102. Physiologic signals include, without limitation, skin impedance, electro cardiogram signals, conductively transmitted current signal, position of wearer, temperature, heart rate, perspiration rate, humidity, altitude/pressure, global positioning system (GPS), proximity, bacteria levels, glucose level, chemical markers, blood oxygen levels, among other physiologic and physical parameters such as fingerprints of the subject 102. Transbody conductive signals include, without limitation, electrical currents that are transmitted through the body of a subject, where the body acts as the conduction medium. In one aspect, transbody conductive signals can be generated by an ingestible event marker system 1106, one example of which is described in connection with FIGS. 7 and 8. In other aspects, transbody conductive signals can be generated by electrical circuits placed in electrical contact with the surface of the skin of the subject 100 by way of a body-associated personal communicator 104. In other aspects, transbody conductive signals can be generated by electrical circuits implanted within the body of the subject 102. Additional aspects of mobile devices 1102 configured for detecting an electrical signal from an ingestible event marker system 1106, among others, are described in commonly assigned International PCT Application PCT/US/2012/047076, international publication number WO 2013/012869, which is herein incorporated by reference in its entirety.

Regardless of the source, the unique electrical signals suitable for authentication and/or social-network system 160 interfacing are coupled to the target authentication device, e.g., the mobile device 1102, through at least one of the electrodes 1104a, 1104b, which are suitable for sensing and sourcing electrical signals. In operation, the subject 102 holds the mobile device 1102, or otherwise contacts electrodes on another type of computer system, and physically contacts at least one of the electrodes 1104a, 1104b. The electrical signals are coupled from the subject 102 through at least one of the electrodes 1104a, 1104b to an authentication subsystem. The authentication subsystem can be integrated with the mobile device 1102 or may be added on.

When the ingestible event marker system 1106 is the signal source, a unique electrical current signal is generated when the ingestible event marker system 1106 contacts digestive fluids 1108 in the stomach 1110 of the subject 102. The unique electrical current signature is conducted through the body of the subject 102, is detected by at least one of the electrodes 1104a, 1104b, and is coupled to an authentication subsystem, which decodes the signal and provides a decoded signal to a processing subsystem to authenticate the subject 102.

When the body-associated personal communicator 104 is the signal source, an electrical current signal is generated by circuits in the body-associated personal communicator 104. The body-associated personal communicator 104 is electrically coupled to the body of the subject 102 by another set of electrodes. The electrical signal is conducted by the body and detected by at least one of the input electrodes 1104a, 1104b on the mobile device 1102. These and other aspects of the personal authentication techniques are discussed hereinbelow. Prior to describing such systems, however, the disclosure now turns to measurement subsystems for detecting electrical signals.

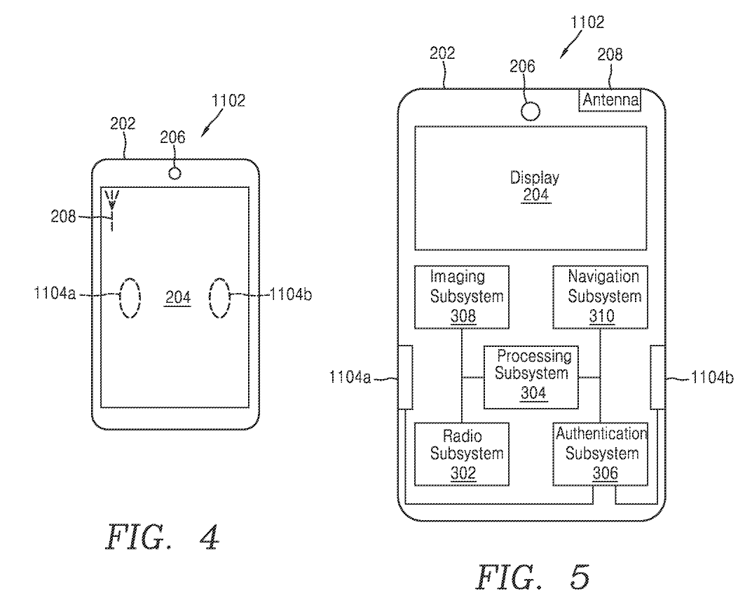

FIG. 4 illustrates one aspect of a mobile device 1102 comprising electrodes 1104a, 1104b for detecting personal electrical signals suitable for authenticating the identity of the subject 102 (FIGS. 1-3) and obtaining physiologic and/or ingestion information from the subject 102. The mobile device 1102 also comprises a housing 202, a display 204, an aperture 206 for capturing digital images, and an antenna 208. The electrodes 1104a, 1104b are located on the back of the housing 202 or at any convenient location of the mobile device 1102. In one aspect, for example, the electrodes 1104a, 1104b may be located on or embedded within a skin or design cover for a mobile device 1102.

FIG. 5 is a diagram of one aspect of a mobile device 1102 configured for detecting electrical signals for authenticating the identity of a subject 102 (FIGS. 1-3) and obtaining physiologic and/or ingestion information from the subject 102. The mobile device 1102 may comprise multiple elements. Although FIG. 5 shows a limited number of elements in a certain topology by way of example, it can be appreciated that additional or fewer elements in any suitable topology may be used in the mobile device 1102 as desired for a given implementation. Furthermore, any element as described herein may be implemented using hardware, software, or a combination of both, as previously described with reference to node implementations. Aspects of the mobile device 1102, however, are not limited in this context.

In various aspects, in addition to a housing 202, a display 204, an aperture 206 for capturing digital images, and an antenna 208, the mobile device 1102 comprises a radio subsystem 302 connected via a bus to a processing subsystem 304. The radio subsystem 302 may perform voice and data communications operations using wireless shared media for the mobile device 1102. The processing subsystem 304 may execute software for the mobile device 1102. A bus may comprise a USB or micro-USB bus and appropriate interfaces, as well as others.

In various aspects, an authentication and/or protection subsystem 306 is coupled to the electrodes 1104a, 1104b. The electrodes 1104a, 1104b are configured to be in physical contact with the subject 102 (FIGS. 1-3) to electrically couple the unique electrical signals to and from the authentication subsystem 306. When the subject 102 physically contacts at least one of the electrodes 1104a, 1104b the authentication subsystem 306 can receive or transmit a unique electrical current signal for authenticating the identity of the subject 102 and, once authenticated, providing access to the mobile device 1102 and/or the social-networking system 160. Also, when the authentication subsystem 306 detects physiologic signals associated with the subject 102, the authentication subsystem 306 builds a database, which over time provides an average of the physiologic signals associated with the subject 102. Authentication occurs only when the detected physiologic signals match the running average physiologic signals stored in the database.

In various aspects, the detection subsystem 306 is coupled to the processing subsystem 304. The detection subsystem 306 converts the detected electrical signals into a secret word or string of characters. A processing subsystem 304 coupled to the detection subsystem 306 uses the string of characters for user authentication to prove identity of the subject 102 (FIGS. 1-3), for access approval to gain access to the mobile device 1102, and/or for access to the social-networking system 160 (FIGS. 1-2). When the subject 102 is authenticated, the processing subsystem 304 activates the radio subsystem 304 and other functional modules of the computing device 1102, such as, for example, an imaging subsystem 308 or a navigation subsystem 310. When the subject 100 is not authenticated, the processing subsystem 304 denies access to the functional modules of the mobile device 1102 until the proper electrical signals are detected by the detection subsystem 306.

In various aspects, the display 204 may comprise any suitable display unit for displaying information appropriate for a mobile device 1102. The I/O system may comprise any suitable I/O device for entering information into the mobile device 1102. Examples for the I/O system may include an alphanumeric keyboard, a numeric keypad, a touch pad, a capacitive touch screen panel, input keys, buttons, switches, rocker switches, voice recognition device and software, and so forth. The I/O system may comprise a microphone and speaker, for example. Information also may be entered into the mobile device 1102 by way of the microphone. Such information may be digitized by a voice recognition device.

In various aspects, the radio subsystem 320 may perform voice and data communications operations using wireless shared media for the mobile device 1102. The processing subsystem 304 may execute software for the mobile device 1102. A bus may comprise a universal serial bus (USB), micro-USB bus, dataport, and appropriate interfaces, as well as others. In one aspect the radio subsystem 302 may be arranged to communicate voice information and control information over one or more assigned frequency bands of the wireless shared media.

In various aspects, the imaging subsystem 308 processes images captured through the aperture 206. A camera may be coupled (e.g., wired or wirelessly) to the processing subsystem 304 and is configured to output image data (photographic data of a person or thing, e.g., video data, digital still image data) to the processing subsystem 304 and to the display 204. In one aspect, the imaging subsystem 308 may comprise a digital camera implemented as an electronic device used to capture and store images electronically in a digital format. Additionally, in some aspects the digital camera may be capable of recording sound and/or video in addition to still images. In other implementations, the imaging subsystem may comprise a fingerprint scanner to obtain one or more fingerprints of the subject 100.

In various aspects, the imaging subsystem 308 may comprise a controller to provide control signals to components of a digital camera, including lens position component, microphone position component, and a flash control module, to provide functionality for the digital camera. In some aspects, the controller may be implemented as, for example, a host processor element of the processing subsystem 304 of the mobile device 1102. Alternatively, the imaging controller may be implemented as a separate processor from the host processor.

In various aspects, the imaging subsystem 308 may comprise memory either as an element of the processing subsystem 304 of the mobile device 1102 or as a separate element. It is worthy to note that in various aspects some portion or the entire memory may be included on the same integrated circuit as the controller. Alternatively, some portion or the entire memory may be disposed on an integrated circuit or other medium (e.g., hard disk drive) external to the integrated circuit of the controller.

In various aspects, the aperture 206 includes a lens component and a lens position component. The lens component may consist of a photographic or optical lens or arrangement of lenses made of a transparent material such as glass, plastic, acrylic or Plexiglass, for example. In one aspect, the one or more lens elements of the lens component may reproduce an image of an object and allow for zooming in or out on the object by mechanically changing the focal length of the lens elements. In various aspects, a digital zoom may be employed in the imaging subsystem 308 to zoom in or out on an image. In some aspects, the one or more lens elements may be used to focus on different portions of an image by varying the focal length of the lens elements. The desired focus can be obtained with an autofocus feature of the digital imaging subsystem 308 or by manually focusing on the desired portion of the image, for example.

In various aspects, the navigation subsystem 310 supports navigation using the mobile device 1102. In various aspects the mobile device 1102 may comprise location or position determination capabilities and may employ one or more location determination techniques including, for example, Global Positioning System (GPS) techniques, Cell Global Identity (CGI) techniques, CGI including timing advance (TA) techniques, Enhanced Forward Link Trilateration (EFLT) techniques, Time Difference of Arrival (TDOA) techniques, Angle of Arrival (AOA) techniques, Advanced Forward Link Trilateration (AFTL) techniques, Observed Time Difference of Arrival (OTDOA), Enhanced Observed Time Difference (EOTD) techniques, Assisted GPS (AGPS) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), among others.

In various aspects, the mobile device 1102 may be configured to operate in one or more location determination modes including, for example, a standalone mode, a mobile station (MS) assisted mode, and/or a MS-based mode. In a standalone mode, such as a standalone GPS mode, the mobile device 1102 may be configured to determine its position without receiving wireless navigation data from the network, though it may receive certain types of position assist data, such as almanac, ephemeris, and coarse data. In a standalone mode, the mobile device 1102 may comprise a local location determination circuit such as a GPS receiver which may be integrated within the housing 202 configured to receive satellite data via the antenna 208 and to calculate a position fix. Local location determination circuit may alternatively comprise a GPS receiver in a second housing separate from the housing 202 but in the vicinity of the mobile device 102 and configured to communicate with the mobile device 1102 wirelessly (e.g., via a PAN, such as Bluetooth). When operating in an MS-assisted mode or an MS-based mode, however, the mobile device 1102 may be configured to communicate over a radio access network (e.g., UMTS radio access network) with a remote computer (e.g., a location determination entity (LDE), a location proxy server (LPS) and/or a mobile positioning center (MPC), among others).

In various aspects, the mobile device 1102 also may comprise a power management subsystem (not shown) to manage power for the mobile device 1102, including the radio subsystem 302, the processing subsystem 304, and other elements of the mobile device 1102. For example, the power management subsystem may include one or more batteries to provide direct current (DC) power, and one or more alternating current (AC) interfaces to draw power from a standard AC main power supply.

In various aspects, the radio subsystem 302 may include an antenna 208. The antenna 208 may broadcast and receive RF energy over the wireless shared media. Examples for the antenna 208 may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. The aspects are not limited in this context.

In various aspects, the antenna 208 may be connected to a multiplexer. The multiplexer multiplexes signals from a power amplifier for delivery to the antenna 208. The multiplexer demultiplexes signals received from the antenna for delivery to an RF chipset.

In various aspects, the multiplexer may be connected to a power amplifier, where the power amplifier may be used to amplify any signals to be transmitted over the wireless shared media. The power amplifier may work in all assigned frequency bands, such as four (4) frequency bands in a quad-band system. The power amplifier also may operate in various modulation modes, such as Gaussian Minimum Shift Keying (GMSK) modulation suitable for GSM systems and 8-ary Phase Shift Keying (8-PSK) modulation suitable for EDGE systems.

In various aspects, the power amplifier may be connected to an RF chipset. The RF chipset also may be connected to the multiplexer. In one aspect, the RF chipset may comprise an RF driver and an RF transceiver. The RF chipset performs all of the modulation and direct conversion operations required for GMSK and 8-PSK signal types for quad-band E-GPRS radio. The RF chipset receives analog in-phase (I) and quadrature (Q) signals from a baseband processor, and converts the I/Q signals to an RF signal suitable for amplification by the power amplifier. Similarly, the RF chipset converts the signals received from the wireless shared media via the antenna 208 and the multiplexer to analog I/Q signals to be sent to the baseband processor. Although the RF chipset may use two chips by way of example, it may be appreciated that the RF chipset may be implemented using more or less chips and still fall within the intended scope of the aspects.

In various aspects, the RF chipset may be connected to the baseband processor, where the baseband processor may perform baseband operations for the radio subsystem 514. The baseband processor may comprise both analog and digital baseband sections. The analog baseband section includes I/Q filters, analog-to-digital converters, digital-to-analog converters, audio circuits, and other circuits. The digital baseband section may include one or more encoders, decoders, equalizers/demodulators, GMSK modulators, GPRS ciphers, transceiver controls, automatic frequency control (AFC), automatic gain control (AGC), power amplifier (PA) ramp control, and other circuits.

In various aspects, the baseband processor also may be connected to one or more memory units via a memory bus. In one aspect, for example, the baseband processor may be connected to a flash memory unit and a secure digital (SD) memory unit. The memory units may be removable or non-removable memory. In one aspect, for example, the baseband processor may use approximately 1.6 megabytes of static read-only memory (SRAM) for E-GPRS and other protocol stack needs.

In various aspects, the baseband processor also may be connected to a subscriber identity module (SIM). The baseband processor may have a SIM interface for the SIM, where the SIM may comprise a smart card that encrypts voice and data transmissions and stores data about the specific user so that the user can be identified and authenticated to the network supplying voice or data communications. The SIM also may store data such as personal phone settings specific to the user and phone numbers. The SIM can be removable or non-removable.

In various aspects, the baseband processor may further include various interfaces for communicating with a host processor of the processing subsystem 304. For example, the baseband processor may have one or more universal asynchronous receiver-transmitter (UART) interfaces, one or more control/status lines to the host processor, one or more control/data lines to the host processor, and one or more audio lines to communicate audio signals to an audio subsystem of processing subsystem 514. The aspects are not limited in this context.

In various aspects, the processing subsystem 304 may provide computing or processing operations for the mobile device 1102 and/or for the authentication subsystem 306. For example, the processing subsystem 304 may be arranged to execute various software programs for the mobile device 1102 as well as several software programs for the authentication subsystem 306. Although the processing subsystem 304 may be used to implement operations for the various aspects as software executed by a processor, it may be appreciated that the operations performed by the processing subsystem 304 also may be implemented using hardware circuits or structures, or a combination of hardware and software, as desired for a particular implementation.

In various aspects, the processing subsystem 304 may include a processor implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In one aspect, for example, a processor may be implemented as a general purpose processor, such as a processor made by Intel Corporation, Santa Clara, Calif. The processor also may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth.

In one aspect, the processing subsystem 304 may include a memory to connect to the processor. The memory may be implemented using any machine-readable or computer-readable media capable of storing data, including both volatile and non-volatile memory. For example, the memory may include ROM, RAM, DRAM, DDRAM, SDRAM, SRAM, PROM, EPROM, EEPROM, flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of the memory may be included on the same integrated circuit as the processor thereby obviating the need for a memory bus. Alternatively some portion or all of the memory may be disposed on an integrated circuit or other medium, for example a hard disk drive, that is external to the integrated circuit of the processor, and the processor may access the memory via a memory bus, for example.

In various aspects, the memory may store one or more software components (e.g., application client modules). A software component may refer to one or more programs, or a portion of a program, used to implement a discrete set of operations. A collection of software components for a given device may be collectively referred to as a software architecture or application framework. A software architecture for the mobile device 102 is described in more detail below.

A software architecture suitable for use with the mobile device 102 may include a user interface (UI) module, an interface module, a data source or backend services module (data source), and a third party API module. An optional LBS module may comprise a user based permission module, a parser module (e.g., National Maritime Electronic Association or NMEA), a location information source module, and a position information source module. In some aspects, some software components may be omitted and others added. Further, operations for some programs may be separated into additional software components, or consolidated into fewer software components, as desired for a given implementation. The mobile device 102 software architecture may comprise several elements, components or modules, collectively referred to herein as a “module.” A module may be implemented as a circuit, an integrated circuit, an application specific integrated circuit (ASIC), an integrated circuit array, a chipset comprising an integrated circuit or an integrated circuit array, a logic circuit, a memory, an element of an integrated circuit array or a chipset, a stacked integrated circuit array, a processor, a digital signal processor, a programmable logic device, code, firmware, software, and any combination thereof.

Having described the mobile device 1102 as one example of computer system, it will be appreciated that any of the following computer systems, without limitation, computer networks, desktop computers, laptop computers, notebook computers, tablet computers, tablet computers, mobile phones, personal digital assistants, appliances, positioning systems, media devices, automatic teller machines (ATM), kiosks, public modes of transportation (bus, train, subway, airplane, boat, rental car, . . . ), building entrances, stadiums, turnstiles, medical systems that dispense medication in any form could be equipped with at least one electrode and a detection subsystem to authenticate the user as the owner of the computer system for security purposes. For the sake of conciseness and clarity, not all of these computer systems will be discussed here.

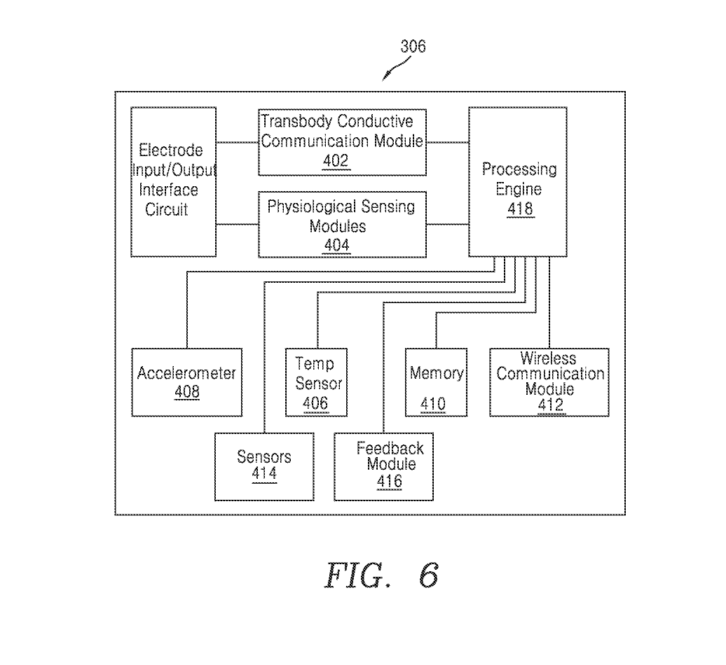

Turning now to FIG. 6, which is a block functional diagram of one aspect of a subsystem 306 for detecting and/or generating personal electrical signals to authenticate the user and prove the identity of the subject 102 (FIGS. 1-3). The subsystem 306 comprises an electrode input/output interface circuit 401 to receive/transmit electrical signals from/to the electrodes 1104a, 1104b (FIGS. 3-5). The subsystem 306 can be configured to operate in receive mode, broadcast mode, or combinations thereof. In receive mode, the input/output interface circuit 401 receives electrical signals from the electrodes 1104a, 1104b. In broadcast mode, the input/output interface circuit 401 transmits electrical signals to the electrodes 1104a, 1104b.

A transbody conductive communication module 402 and a physiologic sensing module 404 are electrically coupled to the electrode input/output interface circuit 401. In one aspect, the transbody conductive communication module 402 is implemented as a first, e.g., high, frequency (HF) signal chain and the physiologic sensing module 404 is implemented as a second, e.g., low, frequency (LF) signal chain. Also shown are CMOS temperature sensing module 406 (for detecting ambient temperature) and a 3-axis accelerometer 408. The subsystem 306 also comprises a processing engine 418 (for example, a microcontroller and digital signal processor), a non-volatile memory 410 (for data storage), and a wireless communication module 412 to receive data from and/or transmit data to another device, for example in a data download/upload action, respectively. In various aspects, the communication module 412 may comprise one or more transmitters/receivers (“transceiver”) modules. As used herein, the term “transceiver” may be used in a very general sense to include a transmitter, a receiver, or a combination of both, without limitation. In one aspect, the transbody conductive communication module 402 is configured to communicate with an ingestible event marker system 1106 (FIG. 3). In receive mode, the transbody conductive communication module 402 is configured to receive a transconduction current signal from the subject 102 (FIGS. 1-3) via at least one of the electrodes 1104a, 1104b (FIGS. 3-5). In broadcast mode, the transbody conductive communication module 402 is configured to transmit a transconduction current signal to the subject 100 via at least one of the electrodes 1104a, 1104b. In one aspect, the transbody conductive communication module 402 is configured as a skin or design cover for a mobile device.

The sensors 414 typically contact the subject 102 (FIGS. 1-3), e.g., are removably attachable to the torso. In various aspects, the sensors 414 may be removably or permanently attached to the authentication subsystem 306. For example, the sensors 414 may be removably connected to another device by snapping metal studs. The sensors 414 may comprise, for example, various devices capable of sensing or receiving the physiologic data. The types of sensors 414 include, for example, electrodes such as biocompatible electrodes. The sensors 414 may be configured, for example, as a pressure sensor, a motion sensor, an accelerometer, an electromyography (EMG) sensor, an event marker system, a biopotential sensor, an electrocardiogram sensor, a temperature sensor, a tactile event marker sensor, and an impedance sensor.

The feedback module 416 may be implemented with software, hardware, circuitry, various devices, and combinations thereof. The function of the feedback module 416 is to provide communication with the subject 102 (FIGS. 1-3) in a discreet, tactful, circumspect manner as described above. In various aspects the feedback module 416 may be implemented to communicate with the subject 102 using techniques that employ visual, audio, vibratory/tactile, olfactory, and taste.

With reference to FIG. 7, there is shown one aspect of an ingestible device event indicator system (e.g., IEM) with dissimilar metals positioned on opposite ends as system 2030. The system 2030 can be used in association with any pharmaceutical product, as mentioned above, to determine when a patient takes the pharmaceutical product. As indicated above, the scope of the present invention is not limited by the environment and the product that is used with the system 2030. For example, the system 2030 may be placed within a capsule and the capsule is placed within the conducting liquid. The capsule would then dissolve over a period of time and release the system 2030 into the conducting liquid. Thus, in one aspect, the capsule would contain the system 2030 and no product. Such a capsule may then be used in any environment where a conducting liquid is present and with any product. For example, the capsule may be dropped into a container filled with jet fuel, salt water, tomato sauce, motor oil, or any similar product. Additionally, the capsule containing the system 2030 may be ingested at the same time that any pharmaceutical product is ingested in order to record the occurrence of the event, such as when the product was taken.

In the specific example of the system 2030 combined with the pharmaceutical product, as the product or pill is ingested, the system 2030 is activated. The system 2030 controls conductance to produce a unique current signature that is detected, thereby signifying that the pharmaceutical product has been taken. The system 2030 includes a framework 2032. The framework 2032 is a chassis for the system 2030 and multiple components are attached to, deposited upon, or secured to the framework 2032. In this aspect of the system 2030, a digestible material 2034 is physically associated with the framework 2032. The material 2034 may be chemically deposited on, evaporated onto, secured to, or built-up on the framework all of which may be referred to herein as “deposit” with respect to the framework 2032. The material 2034 is deposited on one side of the framework 2032. The materials of interest that can be used as material 2034 include, but are not limited to: Cu or CuI. The material 2034 is deposited by physical vapor deposition, electrodeposition, or plasma deposition, among other protocols. The material 2034 may be from about 0.05 to about 500 .mu.m thick, such as from about 5 to about 100 .mu.m thick. The shape is controlled by shadow mask deposition, or photolithography and etching. Additionally, even though only one region is shown for depositing the material, each system 2030 may contain two or more electrically unique regions where the material 2034 may be deposited, as desired.

At a different side, which is the opposite side as shown in FIG. 7, another digestible material 2036 is deposited, such that materials 2034 and 2036 are dissimilar. Although not shown, the different side selected may be the side next to the side selected for the material 2034. The scope of the present invention is not limited by the side selected and the term “different side” can mean any of the multiple sides that are different from the first selected side. Furthermore, even though the shape of the system is shown as a square, the shape maybe any geometrically suitable shape. Material 2034 and 2036 are selected such that they produce a voltage potential difference when the system 2030 is in contact with conducting liquid, such as body fluids. The materials of interest for material 2036 include, but are not limited to: Mg, Zn, or other electronegative metals. As indicated above with respect to the material 2034, the material 2036 may be chemically deposited on, evaporated onto, secured to, or built-up on the framework. Also, an adhesion layer may be necessary to help the material 2036 (as well as material 2034 when needed) to adhere to the framework 2032. Typical adhesion layers for the material 2036 are Ti, TiW, Cr or similar material. Anode material and the adhesion layer may be deposited by physical vapor deposition, electrodeposition or plasma deposition. The material 2036 may be from about 0.05 to about 500 μm thick, such as from about 5 to about 100 μm thick. However, the scope of the present invention is not limited by the thickness of any of the materials nor by the type of process used to deposit or secure the materials to the framework 2032.

Thus, when the system 2030 is in contact with the conducting liquid, a current path, an example is shown in FIG. 7, is formed through the conducting liquid between material 2034 and 2036. A control device 2038 is secured to the framework 2032 and electrically coupled to the materials 2034 and 2036. The control device 2038 includes electronic circuitry, for example control logic that is capable of controlling and altering the conductance between the materials 2034 and 2036.

The voltage potential created between the materials 2034 and 2036 provides the power for operating the system as well as produces the current flow through the conducting fluid and the system. In one aspect, the system operates in direct current mode. In an alternative aspect, the system controls the direction of the current so that the direction of current is reversed in a cyclic manner, similar to alternating current. As the system reaches the conducting fluid or the electrolyte, where the fluid or electrolyte component is provided by a physiologic fluid, e.g., stomach acid, the path for current flow between the materials 2034 and 2036 is completed external to the system 2030; the current path through the system 2030 is controlled by the control device 2038. Completion of the current path allows for the current to flow and in turn a receiver, not shown, can detect the presence of the current and recognize that the system 2030 has been activate and the desired event is occurring or has occurred.

In one aspect, the two materials 2034 and 2036 are similar in function to the two electrodes needed for a direct current power source, such as a battery. The conducting liquid acts as the electrolyte needed to complete the power source. The completed power source described is defined by the physical chemical reaction between the materials 2034 and 2036 of the system 2030 and the surrounding fluids of the body. The completed power source may be viewed as a power source that exploits reverse electrolysis in an ionic or a conductive solution such as gastric fluid, blood, or other bodily fluids and some tissues. Additionally, the environment may be something other than a body and the liquid may be any conducting liquid. For example, the conducting fluid may be salt water or a metallic based paint.

In certain aspects, these two materials are shielded from the surrounding environment by an additional layer of material. Accordingly, when the shield is dissolved and the two dissimilar materials are exposed to the target site, a voltage potential is generated.

Referring again to FIG. 7, the materials 2034 and 2036 provide the voltage potential to activate the control device 2038. Once the control device 2038 is activated or powered up, the control device 2038 can alter conductance between the materials 2034 and 2036 in a unique manner. By altering the conductance between materials 2034 and 2036, the control device 2038 is capable of controlling the magnitude of the current through the conducting liquid that surrounds the system 2030. This produces a unique current signature that can be detected and measured by a receiver (not shown), which can be positioned internal or external to the body. In addition to controlling the magnitude of the current path between the materials, non-conducting materials, membrane, or “skirt” are used to increase the “length” of the current path and, hence, act to boost the conductance path, as disclosed in the U.S. patent application Ser. No. 12/238,345 entitled, “In-Body Device with Virtual Dipole Signal Amplification” filed Sep. 25, 2008, the entire content of which is incorporated herein by reference. Alternatively, throughout the disclosure herein, the terms “non-conducting material”, “membrane”, and “skirt” are interchangeably with the term “current path extender” without impacting the scope or the present aspects and the claims herein. The skirt, shown in portion at 2035 and 2037, respectively, may be associated with, e.g., secured to, the framework 2032. Various shapes and configurations for the skirt are contemplated as within the scope of the present invention. For example, the system 2030 may be surrounded entirely or partially by the skirt and the skirt maybe positioned along a central axis of the system 2030 or off-center relative to a central axis. Thus, the scope of the present invention as claimed herein is not limited by the shape or size of the skirt. Furthermore, in other aspects, the materials 2034 and 2036 may be separated by one skirt that is positioned in any defined region between the materials 2034 and 2036.

Referring now to FIG. 8, in another aspect of an ingestible device is shown in more detail as system 2040. The system 2040 includes a framework 2042. The framework 2042 is similar to the framework 2032 of FIG. 7. In this aspect of the system 2040, a digestible or dissolvable material 2044 is deposited on a portion of one side of the framework 2042. At a different portion of the same side of the framework 2042, another digestible material 2046 is deposited, such that materials 2044 and 2046 are dissimilar. More specifically, material 2044 and 2046 are selected such that they form a voltage potential difference when in contact with a conducting liquid, such as body fluids. Thus, when the system 2040 is in contact with and/or partially in contact with the conducting liquid, then a current path, an example is shown in FIG. 9, is formed through the conducting liquid between material 2044 and 2046. A control device 2048 is secured to the framework 2042 and electrically coupled to the materials 2044 and 2046. The control device 2048 includes electronic circuitry that is capable of controlling part of the conductance path between the materials 2044 and 2046. The materials 2044 and 2046 are separated by a non-conducting skirt 2049. Various examples of the skirt 2049 are disclosed in U.S. Provisional Application No. 61/173,511 filed on Apr. 28, 2009 and entitled “HIGHLY RELIABLE INGESTIBLE EVENT MARKERS AND METHODS OF USING SAME” and U.S. Provisional Application No. 61/173,564 filed on Apr. 28, 2009 and entitled “INGESTIBLE EVENT MARKERS HAVING SIGNAL AMPLIFIERS THAT COMPRISE AN ACTIVE AGENT”; as well as U.S. application Ser. No. 12/238,345 filed Sep. 25, 2008 and published as 2009-0082645, entitled “IN-BODY DEVICE WITH VIRTUAL DIPOLE SIGNAL AMPLIFICATION”; the entire disclosure of each is incorporated herein by reference.

Once the control device 2048 is activated or powered up, the control device 2048 can alter conductance between the materials 2044 and 2046. Thus, the control device 2048 is capable of controlling the magnitude of the current through the conducting liquid that surrounds the system 2040. As indicated above with respect to system 2030, a unique current signature that is associated with the system 2040 can be detected by a receiver (not shown) to mark the activation of the system 2040. In order to increase the “length” of the current path the size of the skirt 2049 is altered. The longer the current path, the easier it may be for the receiver to detect the current.

Referring now to FIG. 9, the system 2030 of FIG. 7 is shown in an activated state and in contact with conducting liquid. The system 2030 is grounded through ground contact 2052. The system 2030 also includes a sensor module 2074, which is described in greater detail with respect to FIG. 9 ion or current paths 2050 form between material 2034 to material 2036 through the conducting fluid in contact with the system 2030. The voltage potential created between the material 2034 and 2036 is created through chemical reactions between materials 2034/2036 and the conducting fluid.

FIG. 9A shows an exploded view of the surface of the material 2034. The surface of the material 2034 is not planar, but rather an irregular surface 2054 as shown. The irregular surface 2054 increases the surface area of the material and, hence, the area that comes in contact with the conducting fluid.

In one aspect, at the surface of the material 2034, there is chemical reaction between the material 2034 and the surrounding conducting fluid such that mass is released into the conducting fluid. The term “mass” as used herein refers to protons and neutrons that form a substance. One example includes the instant where the material is CuCl and when in contact with the conducting fluid, CuCl becomes Cu (solid) and Cl.sup.− in solution. The flow of ions into the conduction fluid is depicted by the ion paths 2050. In a similar manner, there is a chemical reaction between the material 2036 and the surrounding conducting fluid and ions are captured by the material 2036. The release of ions at the material 2034 and capture of ion by the material 2036 is collectively referred to as the ionic exchange. The rate of ionic exchange and, hence the ionic emission rate or flow, is controlled by the control device 2038. The control device 2038 can increase or decrease the rate of ion flow by altering the conductance, which alters the impedance, between the materials 2034 and 2036. Through controlling the ion exchange, the system 2030 can encode information in the ionic exchange process. Thus, the system 2030 uses ionic emission to encode information in the ionic exchange.

The control device 2038 can vary the duration of a fixed ionic exchange rate or current flow magnitude while keeping the rate or magnitude near constant, similar to when the frequency is modulated and the amplitude is constant. Also, the control device 2038 can vary the level of the ionic exchange rate or the magnitude of the current flow while keeping the duration near constant. Thus, using various combinations of changes in duration and altering the rate or magnitude, the control device 2038 encodes information in the current flow or the ionic exchange. For example, the control device 2038 may use, but is not limited to any of the following techniques namely, Binary Phase-Shift Keying (PSK), Frequency modulation, Amplitude modulation, on-off keying, and PSK with on-off keying.

As indicated above, the various aspects disclosed herein, such as systems 2030 and 2040 of FIGS. 7 and 8, respectively, include electronic components as part of the control device 2038 or the control device 2048. Components that may be present include but are not limited to: logic and/or memory elements, an integrated circuit, an inductor, a resistor, and sensors for measuring various parameters. Each component may be secured to the framework and/or to another component. The components on the surface of the support may be laid out in any convenient configuration. Where two or more components are present on the surface of the solid support, interconnects may be provided.

As indicated above, the system, such as system 2030 and 2040, control the conductance between the dissimilar materials and, hence, the rate of ionic exchange or the current flow. Through altering the conductance in a specific manner the system is capable of encoding information in the ionic exchange and the current signature. The ionic exchange or the current signature is used to uniquely identify the specific system. Additionally, the systems 2030 and 2040 are capable of producing various different unique exchanges or signatures and, thus, provide additional information. For example, a second current signature based on a second conductance alteration pattern may be used to provide additional information, which information may be related to the physical environment. To further illustrate, a first current signature may be a very low current state that maintains an oscillator on the chip and a second current signature may be a current state at least a factor of ten higher than the current state associated with the first current signature.

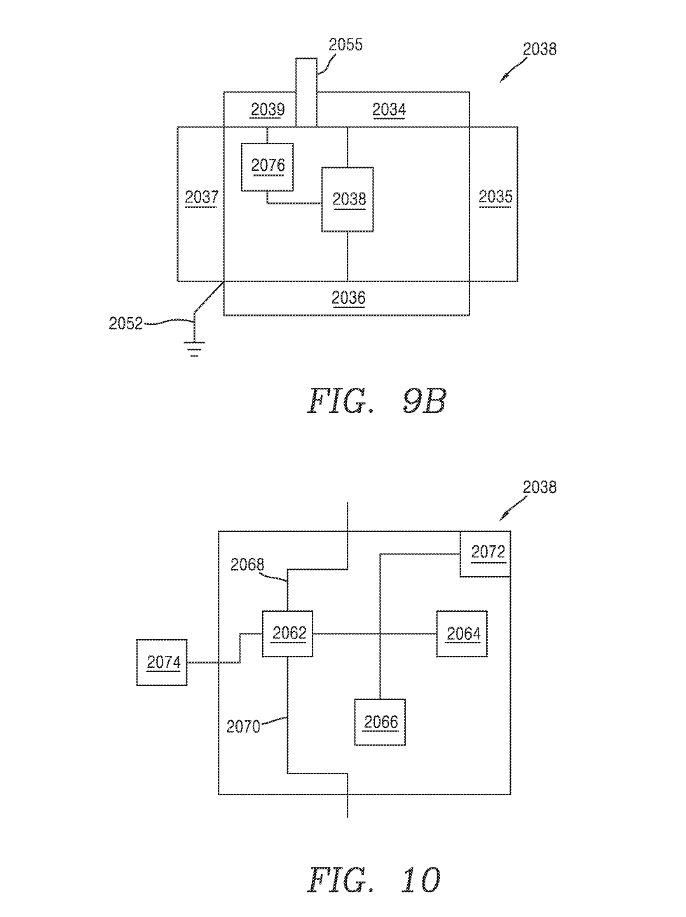

Referring now to FIG. 10, a block diagram representation of the control device 2038 is shown. The device 2030 includes a control module 2062, a counter or clock 2064, and a memory 2066. Additionally, the device 2038 is shown to include a sensor module 2072 as well as the sensor module 2074, which was referenced in FIG. 9. The control module 2062 has an input 2068 electrically coupled to the material 2034 and an output 2070 electrically coupled to the material 2036. The control module 2062, the clock 2064, the memory 2066, and the sensor modules 2072/2074 also have power inputs (some not shown). The power for each of these components is supplied by the voltage potential produced by the chemical reaction between materials 2034 and 2036 and the conducting fluid, when the system 2030 is in contact with the conducting fluid. The control module 2062 controls the conductance through logic that alters the overall impedance of the system 2030. The control module 2062 is electrically coupled to the clock 2064. The clock 2064 provides a clock cycle to the control module 2062. Based upon the programmed characteristics of the control module 2062, when a set number of clock cycles have passed, the control module 2062 alters the conductance characteristics between materials 2034 and 2036. This cycle is repeated and thereby the control device 2038 produces a unique current signature characteristic. The control module 2062 is also electrically coupled to the memory 2066. Both the clock 2064 and the memory 2066 are powered by the voltage potential created between the materials 2034 and 2036.

The control module 2062 is also electrically coupled to and in communication with the sensor modules 2072 and 2074. In the aspect shown, the sensor module 2072 is part of the control device 2038 and the sensor module 2074 is a separate component. In alternative aspects, either one of the sensor modules 2072 and 2074 can be used without the other and the scope of the present invention is not limited by the structural or functional location of the sensor modules 2072 or 2074. Additionally, any component of the system 2030 may be functionally or structurally moved, combined, or repositioned without limiting the scope of the present invention as claimed. Thus, it is possible to have one single structure, for example a processor, which is designed to perform the functions of all of the following modules: the control module 2062, the clock 2064, the memory 2066, and the sensor module 2072 or 2074. On the other hand, it is also within the scope of the present invention to have each of these functional components located in independent structures that are linked electrically and able to communicate.

Referring again to FIG. 10, the sensor modules 2072 or 2074 can include any of the following sensors: temperature, pressure, pH level, and conductivity. In one aspect, the sensor modules 2072 or 2074 gather information from the environment and communicate the analog information to the control module 2062. The control module then converts the analog information to digital information and the digital information is encoded in the current flow or the rate of the transfer of mass that produces the ionic flow. In another aspect, the sensor modules 2072 or 2074 gather information from the environment and convert the analog information to digital information and then communicate the digital information to control module 2062. In the aspect shown in FIG. 9, the sensor modules 2074 is shown as being electrically coupled to the material 2034 and 2036 as well as the control device 2038. In another aspect, as shown in FIG. 10, the sensor module 2074 is electrically coupled to the control device 2038 at connection 2078. The connection 2078 acts as both a source for power supply to the sensor module 2074 and a communication channel between the sensor module 2074 and the control device 2038.

Referring now to FIG. 9B, the system 2030 includes a pH sensor module 2076 connected to a material 2039, which is selected in accordance with the specific type of sensing function being performed. The pH sensor module 2076 is also connected to the control device 2038. The material 2039 is electrically isolated from the material 2034 by a non-conductive barrier 2055. In one aspect, the material 2039 is platinum. In operation, the pH sensor module 2076 uses the voltage potential difference between the materials 2034/2036. The pH sensor module 2076 measures the voltage potential difference between the material 2034 and the material 2039 and records that value for later comparison. The pH sensor module 2076 also measures the voltage potential difference between the material 2039 and the material 2036 and records that value for later comparison. The pH sensor module 2076 calculates the pH level of the surrounding environment using the voltage potential values. The pH sensor module 2076 provides that information to the control device 2038. The control device 2038 varies the rate of the transfer of mass that produces the ionic transfer and the current flow to encode the information relevant to the pH level in the ionic transfer, which can be detected by a receiver (not shown). Thus, the system 2030 can determine and provide the information related to the pH level to a source external to the environment.

As indicated above, the control device 2038 can be programmed in advance to output a pre-defined current signature. In another aspect, the system can include a receiver system that can receive programming information when the system is activated. In another aspect, not shown, the switch 2064 and the memory 2066 can be combined into one device.

In addition to the above components, the system 2030 may also include one or other electronic components. Electrical components of interest include, but are not limited to: additional logic and/or memory elements, e.g., in the form of an integrated circuit; a power regulation device, e.g., battery, fuel cell or capacitor; a sensor, a stimulator, etc.; a signal transmission element, e.g., in the form of an antenna, electrode, coil, etc.; a passive element, e.g., an inductor, resistor, etc.

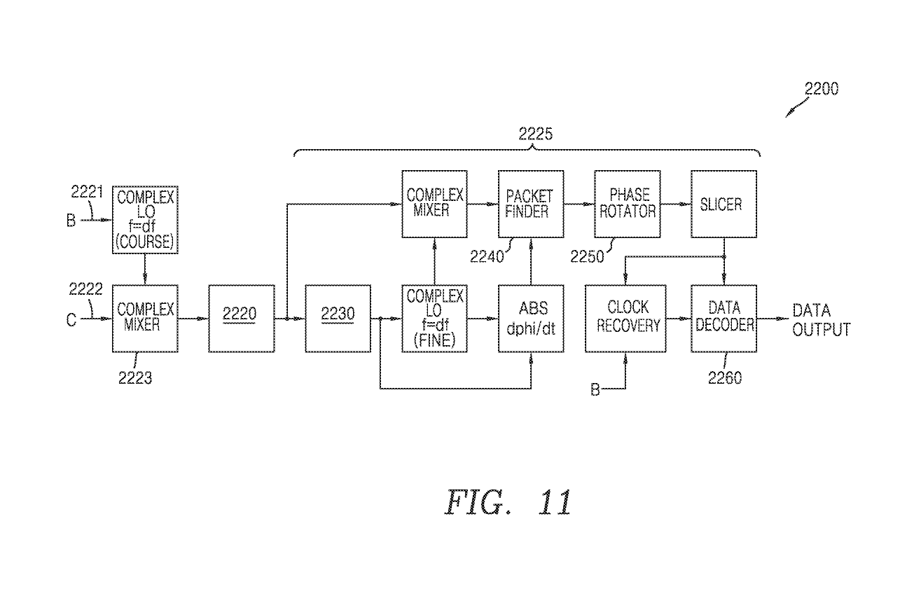

FIG. 11 provides a functional block diagram 2200 of how a receiver (e.g., body-associated personal communicator 104) may implement a coherent demodulation protocol, according to one aspect of the invention. It should be noted that only a portion of the receiver is shown in FIG. 11. FIG. 11 illustrates the process of mixing the signal down to baseband once the carrier frequency (and carrier signal mixed down to carrier offset) is determined. A carrier signal 2221 is mixed with a second carrier signal 2222 at mixer 2223. A narrow low-pass filter 2220 is applied of appropriate bandwidth to reduce the effect of out-of-bound noise. Demodulation occurs at functional blocks 2225 in accordance with the coherent demodulation scheme of the present invention. The unwrapped phase 2230 of the complex signal is determined. An optional third mixer stage, in which the phase evolution is used to estimate the frequency differential between the calculated and real carrier frequency can be applied. The structure of the packet is then leveraged to determine the beginning of the coding region of the BPSK signal at block 2240. Mainly, the presence of the sync header, which appears as an FM porch in the amplitude signal of the complex demodulated signal is used to determine the starting bounds of the packet. Once the starting point of the packet is determined the signal is rotated at block 2250 on the IQ plane and standard bit identification and eventually decoded at block 2260.

In addition to demodulation, the transbody communication module may include a forward error correction module, which module provides additional gain to combat interference from other unwanted signals and noise. Forward error correction functional modules of interest include those described in PCT Application Serial No. PCT/US2007/024225; the disclosure of which is herein incorporated by reference. In some instances, the forward error correction module may employ any convenient protocol, such as Reed-Solomon, Golay, Hamming, BCH, and Turbo protocols to identify and correct (within bounds) decoding errors.

Receivers of the invention, such as the body-associated personal communicator 104, may further employ a beacon functionality module. In various aspects, the beacon switching module may employ one or more of the following: a beacon wakeup module, a beacon signal module, a wave/frequency module, a multiple frequency module, and a modulated signal module.

The beacon switching module may be associated with beacon communications, e.g., a beacon communication channel, a beacon protocol, etc. For the purpose of the present disclosure, beacons are typically signals sent either as part of a message or to augment a message (sometimes referred to herein as “beacon signals”). The beacons may have well-defined characteristics, such as frequency. Beacons may be detected readily in noisy environments and may be used for a trigger to a sniff circuit, such as described below. In one aspect, the beacon switching module may comprise the beacon wakeup module, having wakeup functionality. Wakeup functionality generally comprises the functionality to operate in high power modes only during specific times, e.g., short periods for specific purposes, to receive a signal, etc. An important consideration on a receiver portion of a system is that it be of low power. This feature may be advantageous in an implanted receiver, to provide for both small size and to preserve a long-functioning electrical supply from a battery. The beacon switching module enables these advantages by having the receiver operate in a high power mode for very limited periods of time. Short duty cycles of this kind can provide optimal system size and energy draw features.

In practice, the receiver may “wake up” periodically, and at low energy consumption, to perform a “sniff function” via, for example, a sniff circuit. For the purpose of the present application, the term “sniff function” generally refers to a short, low-power function to determine if a transmitter is present. If a transmitter signal is detected by the sniff function, the device may transition to a higher power communication decode mode. If a transmitter signal is not present, the receiver may return, e.g., immediately return, to sleep mode. In this manner, energy is conserved during relatively long periods when a transmitter signal is not present, while high-power capabilities remain available for efficient decode mode operations during the relatively few periods when a transmit signal is present. Several modes, and combination thereof, may be available for operating the sniff circuit. By matching the needs of a particular system to the sniff circuit configuration, an optimized system may be achieved.

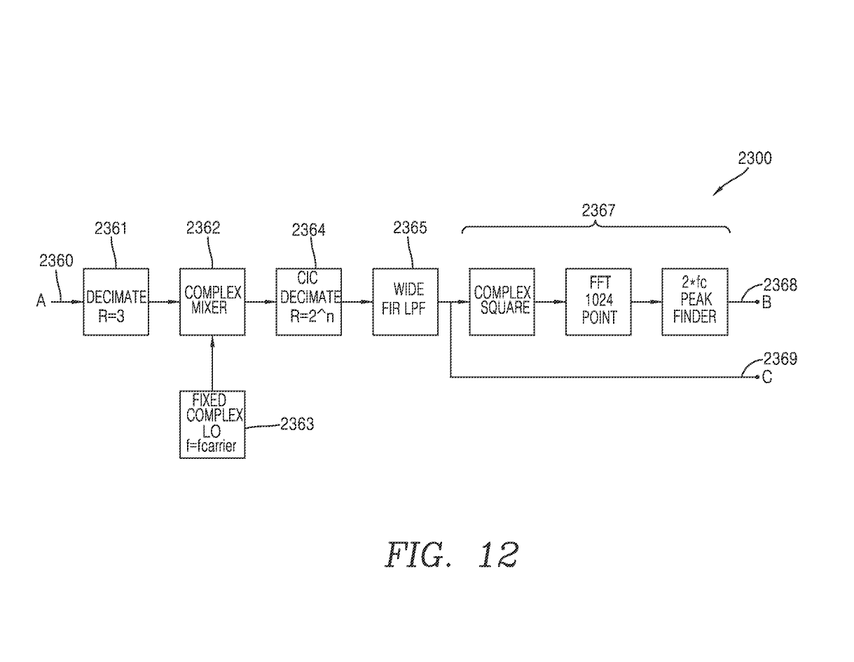

Another view of a beacon module is provided in the functional block diagram shown in FIG. 12. The scheme outlined in FIG. 12 outlines one technique for identifying a valid beacon. The incoming signal 2360 represents the signals received by electrodes, bandpass filtered (such as from 10 KHz to 34 KHz) by a high frequency signaling chain (which encompasses the carrier frequency), and converted from analog to digital. The signal 2360 is then decimated at block 2361 and mixed at the nominal drive frequency (such as, 12.5 KHz, 20 KHz, etc.) at mixer 2362. The resulting signal is decimated at block 2364 and low-pass filtered (such as 5 KHz BW) at block 2365 to produce the carrier signal mixed down to carrier offset—signal 2369. Signal 2369 is further processed by blocks 2367 (fast Fourier transform and then detection of two strongest peaks) to provide the true carrier frequency signal 2368. This protocol allows for accurate determination of the carrier frequency of the transmitted beacon.

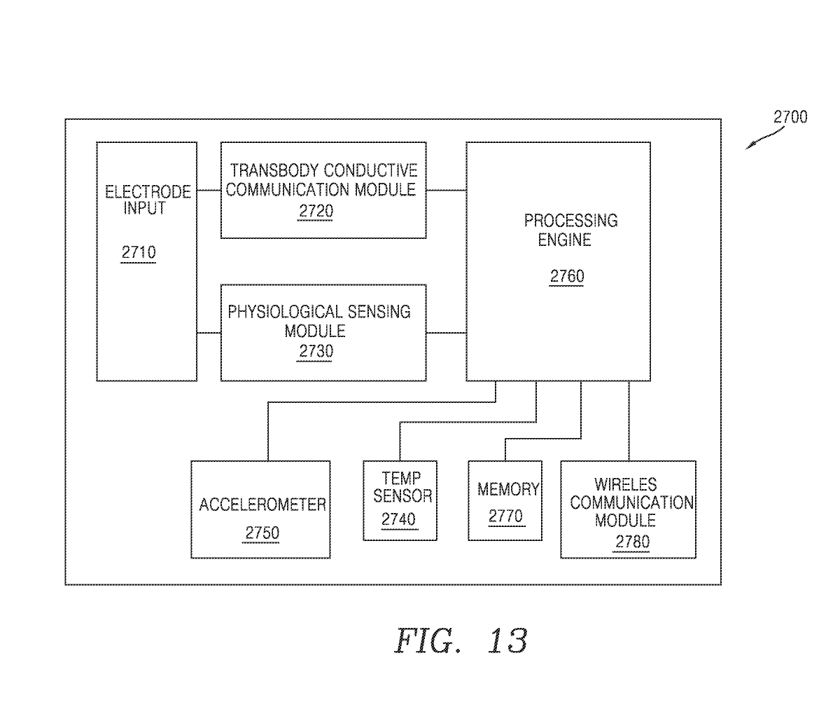

FIG. 13 provides a block functional diagram of an integrated circuit component of a signal receiver (e.g., body-associated personal communicator 104) according to an aspect of the invention. In FIG. 13, receiver 2700 includes electrode input 2710. Electrically coupled to the electrode input 2710 are transbody conductive communication module 2720 and physiologic sensing module 2730. In one aspect, transbody conductive communication module 2720 is implemented as a high frequency (HF) signal chain and physiologic sensing module 2730 is implemented as a low frequency (LF) signal chain. Also shown are CMOS temperature sensing module 2740 (for detecting ambient temperature) and a 3-axis accelerometer 2750. Receiver 2700 also includes a processing engine 2760 (for example, a microcontroller and digital signal processor), non-volatile memory 2770 (for data storage) and wireless communication module 2780 (for data transmission to another device, for example in a data upload action).

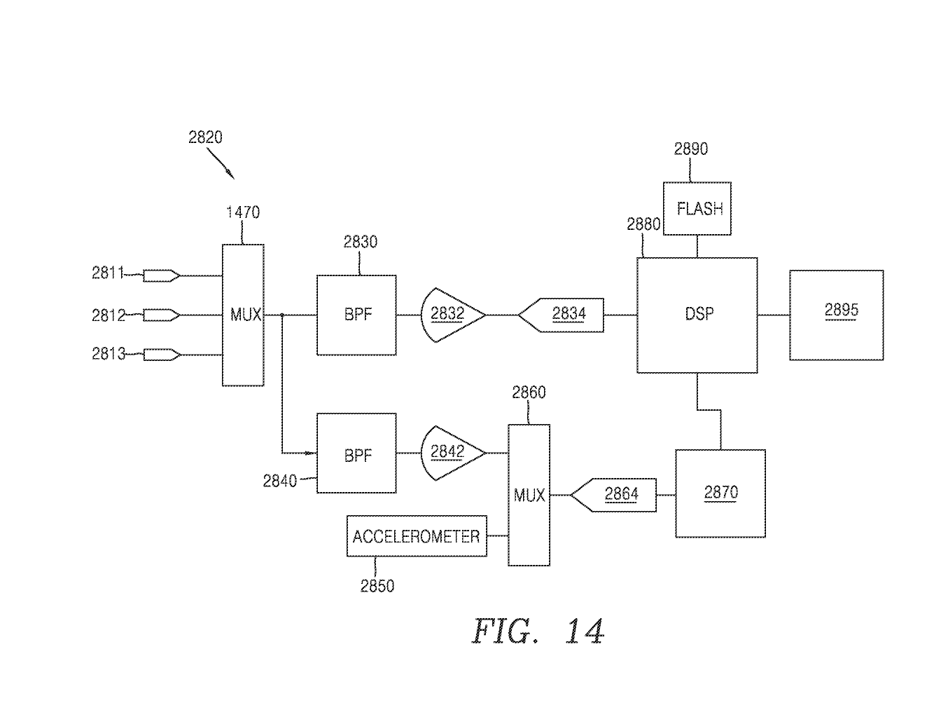

FIG. 14 provides a more detailed block diagram of a circuit configured to implement the block functional diagram of the receiver (e.g., body-associated personal communicator 104) depicted in FIG. 14, according to one aspect of the invention. In FIG. 14, receiver 800 (e.g., body-associated personal communicator 104) includes electrodes e1, e2 and e3 (2811, 2812 and 2813) which, for example, receive the conductively transmitted signals by an IEM and/or sense physiologic parameters or biomarkers of interest. The signals received by the electrodes 2811, 2812, and 2813 are multiplexed by multiplexer 820 which is electrically coupled to the electrodes.

Multiplexer 2820 is electrically coupled to both high band pass filter 2830 and low band pass filter 2840. The high and low frequency signal chains provide for programmable gain to cover the desired level or range. In this specific aspect, high band pass filter 2830 passes frequencies in the 10 KHz to 34 KHz band while filtering out noise from out-of-band frequencies. This high frequency band may vary, and may include, for example, a range of 3 KHz to 300 KHz. The passing frequencies are then amplified by amplifier 2832 before being converted into a digital signal by converter 2834 for input into high power processor 2880 (shown as a DSP) which is electrically coupled to the high frequency signal chain.

Low band pass filter 2840 is shown passing lower frequencies in the range of 0.5 Hz to 150 Hz while filtering out out-of-band frequencies. The frequency band may vary, and may include, for example, frequencies less than 300 Hz, such as less than 200 Hz, including less than 150 Hz. The passing frequency signals are amplified by amplifier 842. Also shown is accelerometer 850 electrically coupled to second multiplexer 2860. Multiplexer 2860 multiplexes the signals from the accelerometer with the amplified signals from amplifier 2842. The multiplexed signals are then converted to digital signals by converter 864 which is also electrically coupled to low power processor 2870.

In one aspect, a digital accelerometer (such as one manufactured by Analog Devices), may be implemented in place of accelerometer 2850. Various advantages may be achieved by using a digital accelerometer. For example, because the signals the digital accelerometer would produce signals already in digital format, the digital accelerometer could bypass converter 2864 and electrically couple to the low power microcontroller 2870—in which case multiplexer 2860 would no longer be required. Also, the digital signal may be configured to turn itself on when detecting motion, further conserving power. In addition, continuous step counting may be implemented. The digital accelerometer may include a FIFO buffer to help control the flow of data sent to the low power processor 2870. For instance, data may be buffered in the FIFO until full, at which time the processor may be triggered to turn awaken from an idle state and receive the data.

Low power processor 2870 may be, for example, an MSP430 microcontroller from Texas Instruments. Low power processor 2870 of receiver 2800 maintains the idle state, which as stated earlier, requires minimal current draw—e.g., 10 pA or less, or 1 pA or less.

High power processor 2880 may be, for example, a VC5509 digital signal process from Texas Instruments. The high power processor 2880 performs the signal processing actions during the active state. These actions, as stated earlier, require larger amounts of current than the idle state—e.g., currents of 30 pA or more, such as 50 pA or more—and may include, for example, actions such as scanning for conductively transmitted signals, processing conductively transmitted signals when received, obtaining and/or processing physiologic data, etc.

The receiver (e.g., body-associated personal communicator 104) may include a hardware accelerator module to process data signals. The hardware accelerator module may be implemented instead of, for example, a DSP. Being a more specialized computation unit, it performs aspects of the signal processing algorithm with fewer transistors (less cost and power) compared to the more general purpose DSP. The blocks of hardware may be used to “accelerate” the performance of important specific function(s). Some architectures for hardware accelerators may be “programmable” via microcode or VLIW assembly. In the course of use, their functions may be accessed by calls to function libraries.

The hardware accelerator (HWA) module comprises an HWA input block to receive an input signal that is to be processed and instructions for processing the input signal; and, an HWA processing block to process the input signal according to the received instructions and to generate a resulting output signal. The resulting output signal may be transmitted as needed by an HWA output block.

Also shown in FIG. 14 is flash memory 2890 electrically coupled to high power processor 2880. In one aspect, flash memory 2890 may be electrically coupled to low power processor 2870, which may provide for better power efficiency.

Wireless communication element 2895 is shown electrically coupled to high power processor 2880 and may include, for example, a BLUETOOTH™ wireless communication transceiver. In one aspect, wireless communication element 2895 is electrically coupled to high power processor 2880. In another aspect, wireless communication element 2895 is electrically coupled to high power processor 2880 and low power processor 2870. Furthermore, wireless communication element 2895 may be implemented to have its own power supply so that it may be turned on and off independently from other components of the receiver—e.g., by a microprocessor.

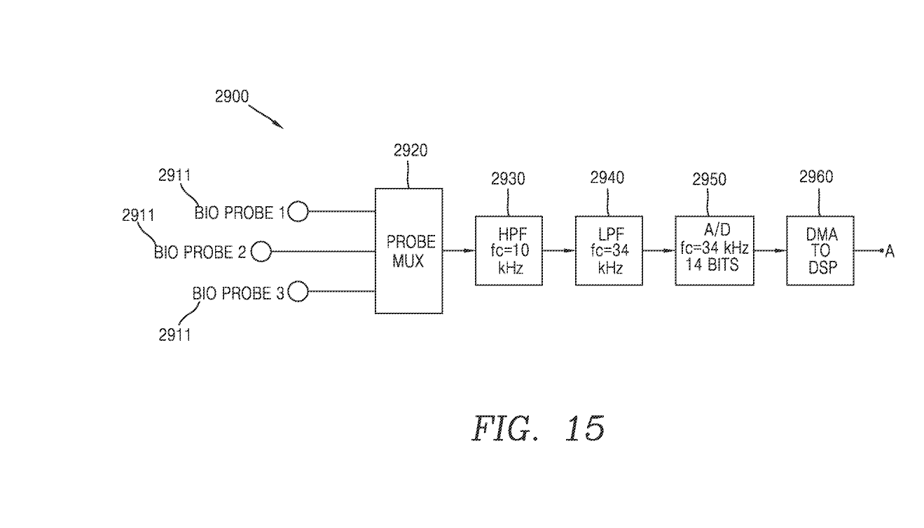

FIG. 15 provides a view of a block diagram of hardware in a receiver (e.g., body-associated personal communicator 104) according to an aspect of the invention related to the high frequency signal chain. In FIG. 15, receiver 2900 includes receiver probes (for example in the form of electrodes 2911, 2912 and 2913) electrically coupled to multiplexer 2920. Also shown are high pass filter 2930 and low pass filter 2940 to provide for a band pass filter which eliminates any out-of-band frequencies. In the aspect shown, a band pass of 10 KHz to 34 KHz is provided to pass carrier signals falling within the frequency band. Example carrier frequencies may include, but are not limited to, 12.5 KHz and 20 KHz. One or more carriers may be present. In addition, receiver 2900 includes analog to digital converter 2950—for example, sampling at 500 KHz. The digital signal can thereafter be processed by the DSP. Shown in this aspect is DMA to DSP unit 960 which sends the digital signal to dedicated memory for the DSP. The direct memory access provides the benefit of allowing the rest of the DSP to remain in a low power mode.

Example Configurations for Various States

As stated earlier, for each receiver state, the high power functional block may be cycled between active and inactive states accordingly. Also, for each receiver state, various receiver elements (such as circuit blocks, power domains within processor, etc.) of a receiver may be configured to independently cycle from on and off by the power supply module. Therefore, the receiver may have different configurations for each state to achieve power efficiency.

In certain aspects, the receivers are part of a body-associated system or network of devices, such as sensors, signal receivers, and optionally other devices, which may be internal and/or external, which provide a variety of different types of information that is ultimately collected and processed by a processor, such as an external processor, which then can provide contextual data about a living subject, such as a patient, as output. For example, the receiver may be a member of an in-body network of devices which can provide an output that includes data about IEM ingestion, one or more physiologic sensed parameters, implantable device operation, etc., to an external collector of the data. The external collector, e.g., in the form of a health care network server, etc., of the data then combines this receiver provided data with additional relevant data about the patient, e.g., weight, weather, medical record data, etc., and may process this disparate data to provide highly specific and contextual patient specific data.

Systems of the invention include, in certain aspects, a signal receiver aspect of a receiver and one or more IEMs. IEMs of interest include those described in PCT application serial no. PCT/US2006/016370 published as WO/2006/116718; PCT application serial no. PCT/US2007/082563 published as WO/2008/052136; PCT application serial no. PCT/US2007/024225 published as WO/2008/063626; PCT application serial no. PCT/US2007/022257 published as WO/2008/066617; PCT application serial no. PCT/US2008/052845 published as WO/2008/095183; PCT application serial no. PCT/US2008/053999 published as WO/2008/101107; PCT application serial no. PCT/US2008/056296 published as WO/2008/112577; PCT application serial no. PCT/US2008/056299 published as WO/2008/112578; and PCT application serial no. PCT/US2008/077753 published as WO 2009/042812; the disclosures of which applications are herein incorporated by reference.

In certain aspects the systems include an external device which is distinct from the receiver (which may be implanted or topically applied in certain aspects), where this external device provides a number of functionalities. Such an external device can include the capacity to provide feedback and appropriate clinical regulation to the patient. Such a device can take any of a number of forms. For example, the device can be configured to sit on the bed next to the patient, e.g., a bedside monitor. Other formats include, but are not limited to, PDAs, smart phones, home computers, etc.

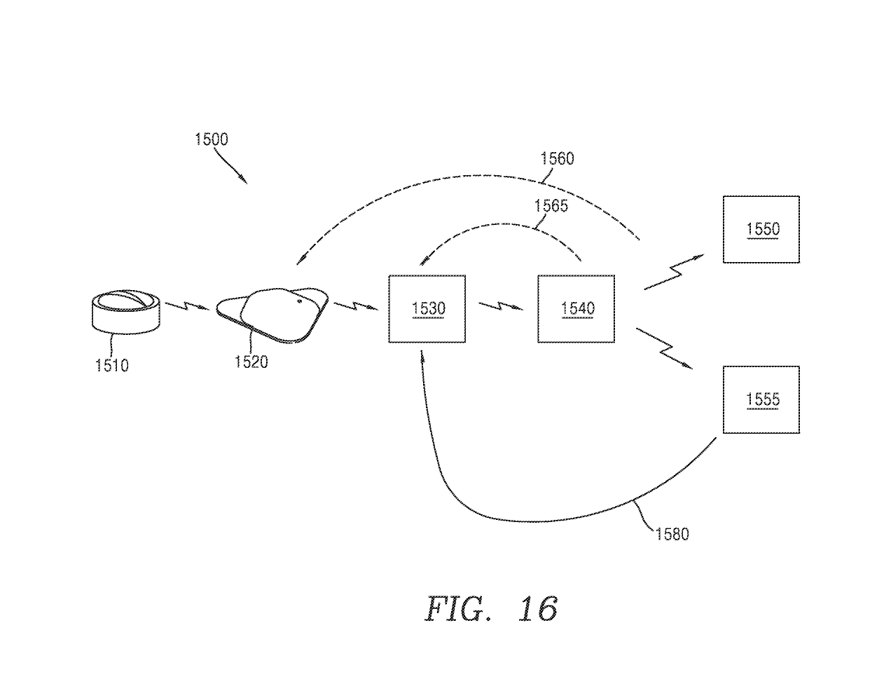

An example of a system of the invention is shown in FIG. 16. In FIG. 16, system 1500 includes a pharmaceutical composition 1510 that comprises an IEM. Also present in system 1500 is signal receiver 1520, such as the signal receiver illustrated in FIG. 11. Signal receiver 1520 is configured to detect a signal emitted from the identifier of the IEM 1510. Signal receiver 1520 also includes physiologic sensing capability, such as ECG and movement sensing capability. Signal receiver 1520 is configured to transmit data to a patient's an external device or PDA 1530 (such as a smart phone or other wireless communication enabled device), which in turn transmits the data to a server 1540. Server 1540 may be configured as desired, e.g., to provide for patient directed permissions. For example, server 1540 may be configured to allow a family caregiver 1550 to participate in the patient's therapeutic regimen, e.g., via an interface (such as a web interface) that allows the family caregiver 1550 to monitor alerts and trends generated by the server 1540, and provide support back to the patient, as indicated by arrow 1560. The server 1540 may also be configured to provide responses directly to the patient, e.g., in the form of patient alerts, patient incentives, etc., as indicated by arrow 1565 which are relayed to the patient via PDA 1530. Server 1540 may also interact with a health care professional (e.g., RN, physician) 1555, which can use data processing algorithms to obtain measures of patient health and compliance, e.g., wellness index summaries, alerts, cross-patient benchmarks, etc., and provide informed clinical communication and support back to the patient, as indicated by arrow 1580. In other embodiments, server 1540 is a social-networking system.

Having described social-network environment associated in which information can be provided to a social-networking system 160 by a body-associated personal communicator 104, the description now turns to various social media applications of social-networking system 160 employing physiologic information received from body-associated personal communicator 104. Various aspects include by way of example and not limitation, timelines, awards/incentives, analytics, grouping, mentoring, mood, emotion, access, identification, among others. Physical networks may be captured by the social-networking system 160 via passive searching of information from body-associated personal communicators 104.

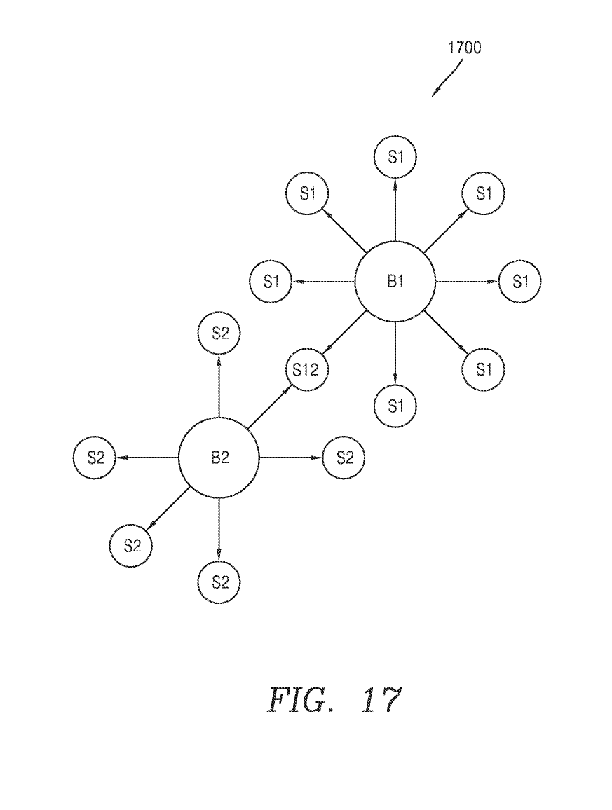

FIG. 17 is a diagram of a communication system 1700 based at least in part on broadcasting short burst bio-language messages based on physiologic information for use with a crowd endorsement system. As shown in FIG. 17, nodes labeled B1 and B2 are broadcast nodes and nodes labeled S1 and S2 are subscribers to broadcast nodes B1 and B2, respectively. The node labeled S 12 is a node that subscribes to both broadcast nodes B1 and B2. Broadcast nodes B1, B2 employ the body-associated personal communicator 104 described throughout this specification to broadcast short burst bio-language messages based on physiologic information to their corresponding subscribers S1, S2, S12. A subscriber S1, S2, S12 can be a person with a computer system such as a body-associated personal communicator 104, a desktop computer, notebook or laptop computer, netbook, tablet computer, e-book reader, GPS device, camera, personal digital assistant (PDA), handheld electronic device, cellular telephone, smartphone, other suitable electronic device, or any suitable combination thereof, or simply objects such as electronic scoreboards at athletic events, electronic billboards or other public or private electronic signage, video screens, television screens, and the like.

In one aspect, the broadcast node B1, B2 wears the body-associated personal communicator 104, which via its sensors, electrodes, and other electrical interfaces, can obtain physiologic information and/or ingestion information from the subject 102. This information can be broadcast by the body-associated personal communicator 104 based on various criteria such as achieving a goal, ingestion a pill, reaching a milestone, performing at a predetermined level of physical activity or exertion, predetermined physiologic parameters (e.g., heart rate, body temperature, blood pressure, perspiration, hydration state, etc.), or simply triggered by the subject 102 using various input mechanism such as, for example, voice, touch screen, keypad, keyboard, touchscreen, electrodes, mouse, pushbutton, haptic, vibratory, among other input mechanisms.

In one aspect, the body-associated personal communicator 104 may comprises inertial sensor comprising an accelerometer, gyroscope, and magnetometer, for example. The signals from the inertial sensors are processed by the body-associated personal communicator 104 to determine physical attributes of the subject 102 such as the state of rest or motion, for example. Accordingly, a broadcast node B1, B2 wearing the body-associated personal communicator 104 may automatically broadcast short burst bio-language messages based on such physiologic information to their subscribers S1, S2, S12.

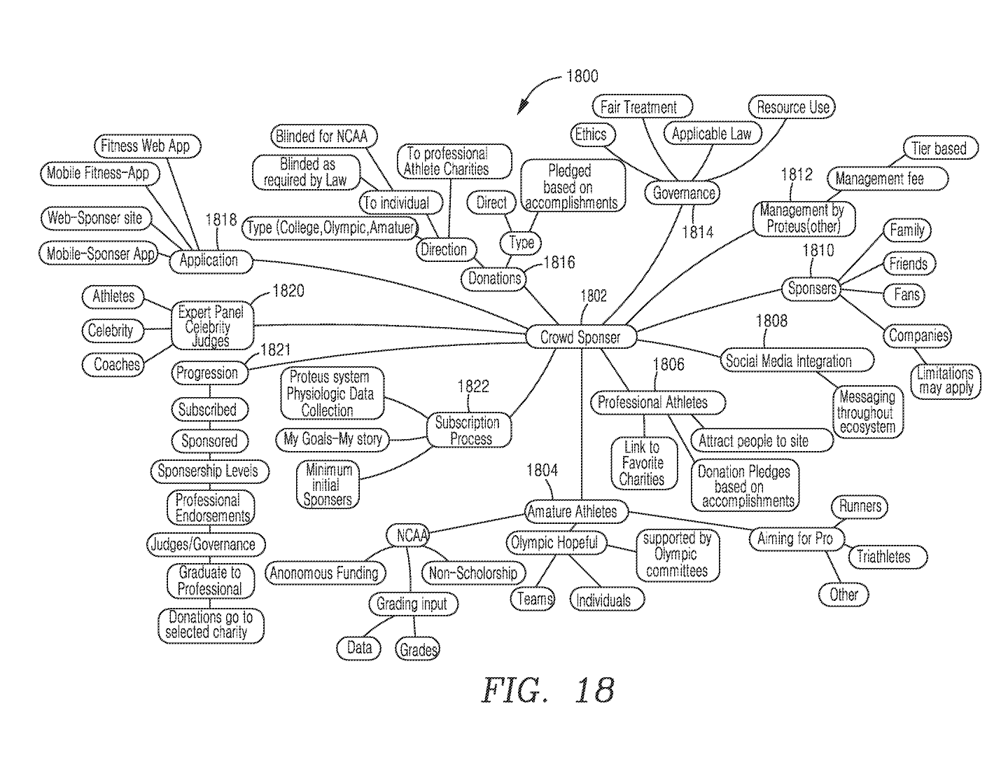

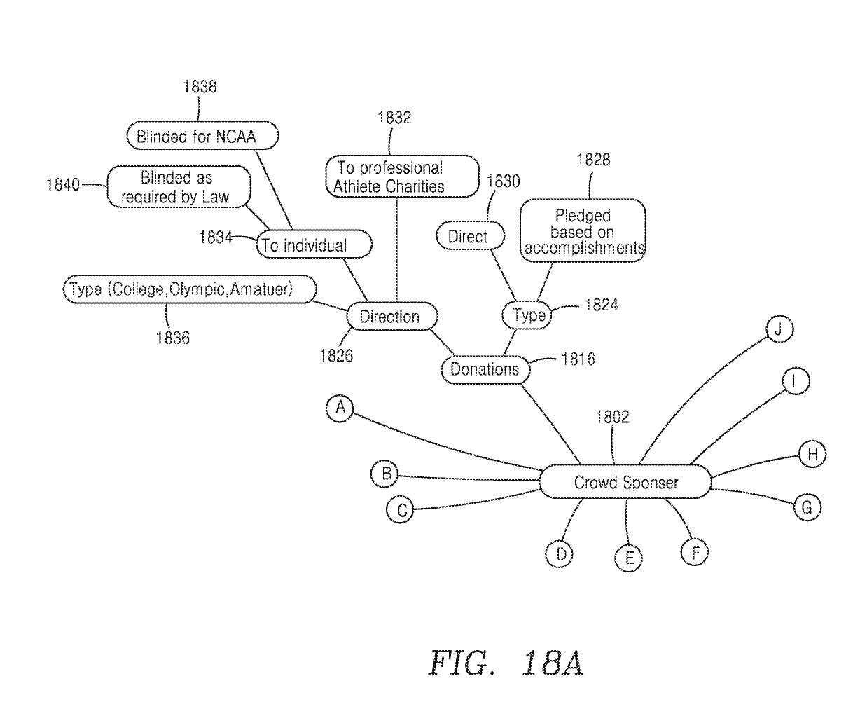

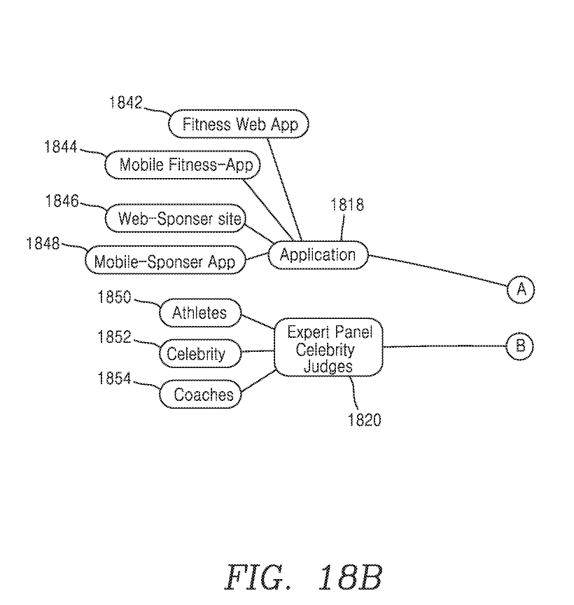

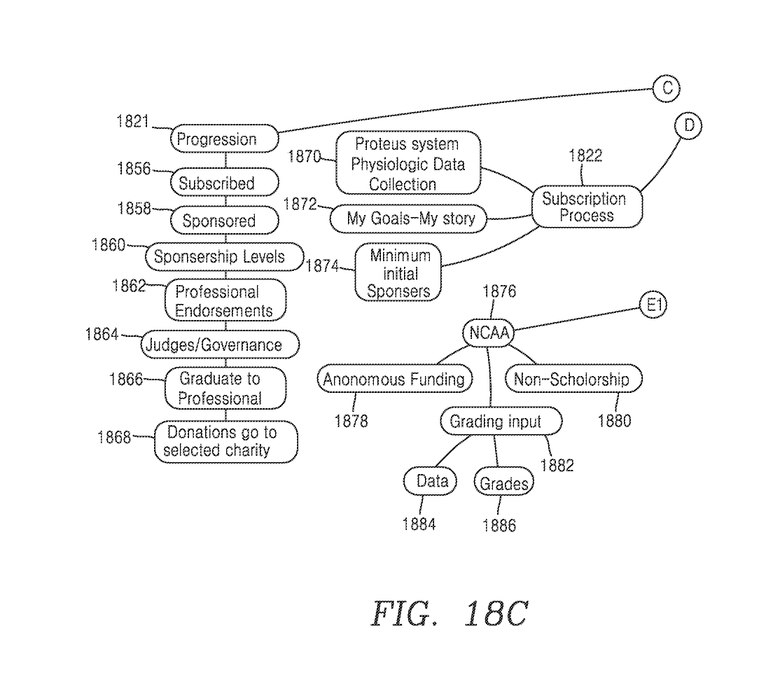

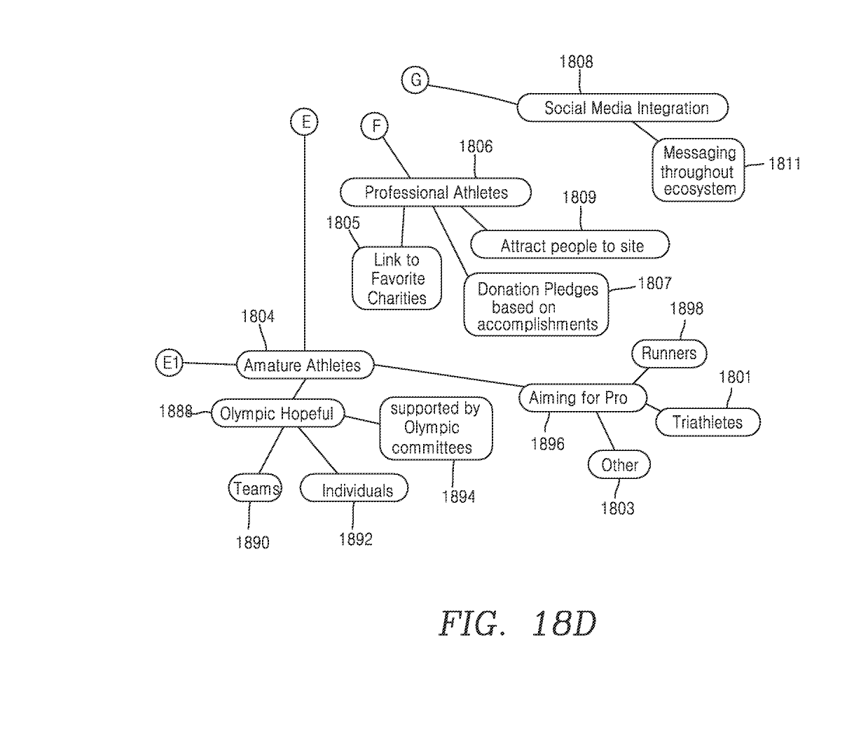

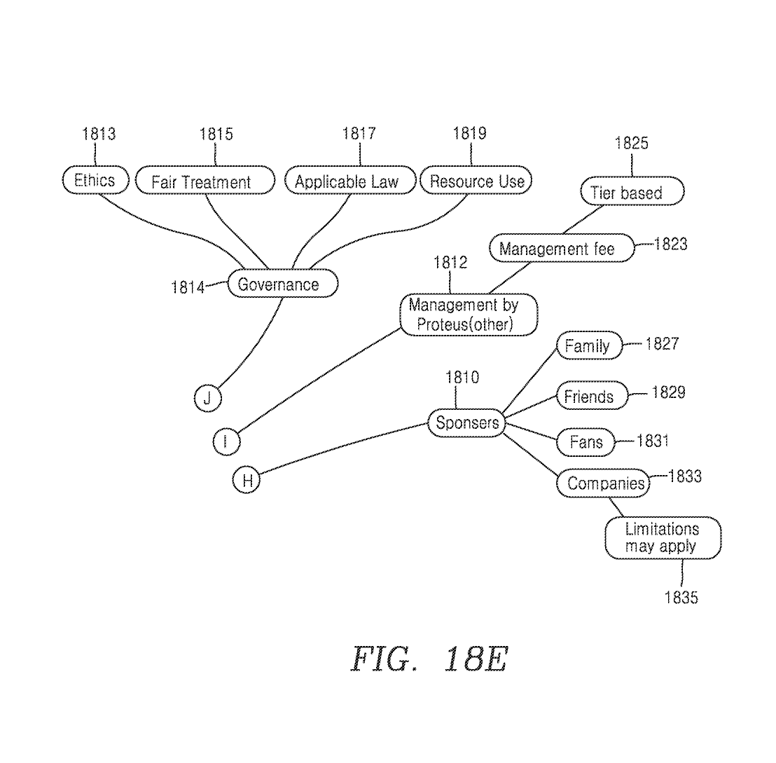

FIG. 18 is a diagram of a crowd endorsement system 1800. The crowd endorsement system 1800 includes a crowd sponsor 1802 that interacts with amateur athletes 1804, professional athletes 1806, social media integration 1808, sponsors 1810, management by third parties 1812, e.g., Proteus, governance 1814, donations 1816, applications 1818, expert panel celebrity judges 1820, progression 1821, and/or subscription processes 1822.

FIG. 18A is a detail view of the donations 1816 aspect of the diagram of a crowd endorsement system shown in FIG. 18. The donations 1816 may be of type 1824 and come from any direction 1826. The donation types 1824 include pledge based donations on accomplishments 1828 or direct donations 1830. The donation direction 1826 may be to professional athlete charities 1832, to an individual 1834, or to a particular type 1836 such as, for example, college, Olympic, amateur. Donations to an individual 1834 may be blinded for NCAA 1838 or blinded as required by law 1840.

FIG. 18B is a detail view of the applications 1818 and expert panel celebrity judges 1820 aspects of the crowd endorsement system diagram shown in FIG. 18. Applications 1818 include fitness web applications 1842, mobile fitness applications 1844, web-sponsor sites 1846, and/or mobile-sponsor sites 1848. Expert panel celebrity judges 1820 include athletes 1850, celebrities 1852, and/or coaches 1854.

FIG. 18C is a detail view of the progression 1821, subscription process 1822, and NCAA 1876 amateur athlete aspects of the crowd endorsement system diagram shown in FIG. 18. The progression 1821 levels include subscribed 1856, sponsored 1858, sponsorship levels 1860, professional endorsements 1862, judges/governance 1864, graduate to professional 1866, and donations going to selected charities 1868. The subscription process 1822 includes a Proteus physiologic data collection system 1870 as described herein in connection with FIGS. 1-17, my goals-my story 1872, and minimum initial sponsors 1874. The amateur athlete 1804 component (FIG. 18) includes an NCAA 1876 component. The NCAA 1876 component includes anonymous funding 1878, non-scholarship funding 1880, and grading input 1882. The grading input 1882 comprises data 1884 and grades 1886.

FIG. 18D is a detail view of the amateur athletes 1804, professional athletes 1806, and social media integration 1808 aspects of the crowd endorsement system diagram shown in FIG. 18. The amateur athletes 1804 include Olympic hopeful 1888, either teams 1890 or individuals 1892. Others includes Olympic hopefuls 1888 supported by the Olympic Committees 1894. Professional athletes 1806 may be employed to link favorite charities 1805, make donation pledges based on accomplishments 1807, and/or attract people to the site 1809. The social media integration aspect 1808 includes messaging throughout the ecosystem 1811.

FIG. 18E is a detail view of the governance 1814, third party management 1812, and sponsors 1810 aspects of the crowd endorsement system diagram shown in FIG. 18. The governance 1814 aspect takes into consideration ethics 1813, fair treatment 1815, applicable law 1817, and resource utilization 1819. The third management 1812 aspect includes a management fee 1823, which may be tier based 1825. Sponsors 1810 may include family 1827, friends 1829, fans 1831, and/or companies 1833, where limitations may apply 1835 to companies 1833.

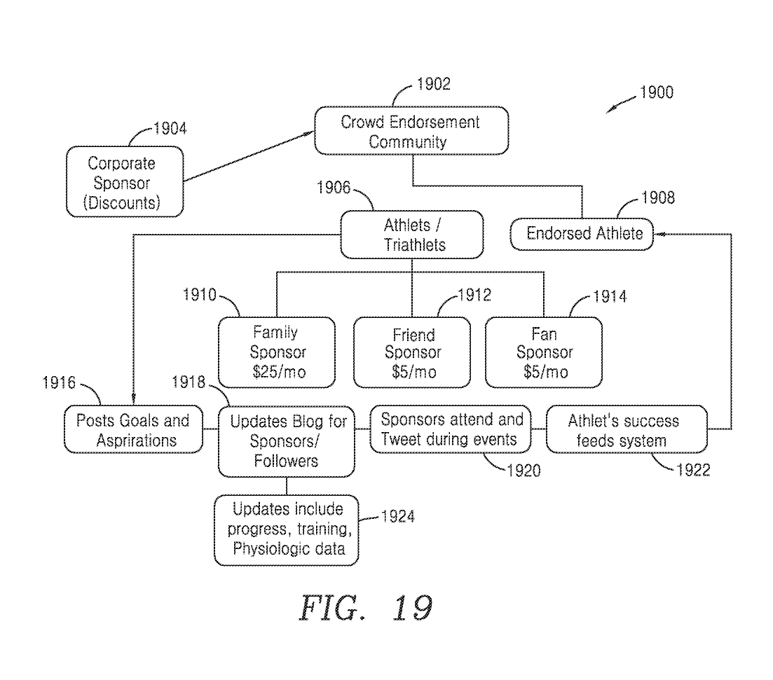

FIG. 19 is a diagram of a crowd endorsement system 1900. In one aspect, the crowd endorsement system 1900 may be implemented as a crowd endorsement social engine. The crowd endorsement social engine enables the following crowd endorsement concepts: income and training support for semi-pro, amateur, Olympic athletes; sponsorship from family, friends, fans, social community; individual athlete campaigns highlight goals, progress and achievement. Athletes produce blog style updates on progress and physiologic tweets during competition. Sponsors create emotional attachment to their athlete and his/her success and provide encouragement. Fans that attended events provide live updates to athletes' pages. Community growth is based on the athlete's adoption and sponsor base.

As shown in FIG. 19, the crowd endorsement system 1900 includes a crowd endorsement community 1902, which may receive endorsements from corporate sponsors 1904 or discounts from corporate sponsors. An athlete 1906 may receive endorsements from family sponsors 1910, friend sponsors 1912, or fan sponsors 194. The athlete 1906 may seek to establish or increase endorsements by posting goals and aspirations 1916 using online media such as social media or broadcast using short burst messaging techniques as described in connection with FIGS. 2 and 17, for example. As part of an ongoing process, the athlete 1906 can update a blog for sponsors/followers 1910, 1912, 1914. In turn, sponsors 1910, 1912, 1914 can attend athletic events and Tweet (broadcast short burst messaging) during the athletic events. The athlete's success feeds the system 1922 and enables the athlete 1906 to become an endorsed athlete 1908 member of the crowd endorsement community 1902. Updates 1918 from the athlete 1906 may include progress, training, and physiologic data 1924, such as the physiologic data gathered and communicated by way of the systems and apparatuses described in connection with FIGS. 1-17 hereinabove.

A typical athlete candidate for crowd endorsement would possess the following background:

DOB: 1/5/1987 Nationality: British

2013 Multisport Results: 1St (2), 2nd (3)

British National Championships 15th amateur

Age Group World Championships 9th age group, 19th overall

Started sport in March 2012

A typical athlete candidate for crowd endorsement would have the following plan:

Goal stated as being the “Worlds Next Great”

Has Put career on hold to focus and has retained a coach and mentor

Building a targeted training and race plan

Technology by Proteus would provide the tool for measuring and tracking recovery to guide training plan and load, analysis of race results combined with pre-race data to provide a quicker path to an optimized formula based on the athlete's body, and the athlete's success will provide opportunities to work with other athletes and with the crowd sponsor community on an experimental bases.

While various details have been set forth in the foregoing description, it will be appreciated that the various aspects of the crowd endorsement system may be practiced without these specific details. For example, for conciseness and clarity selected aspects have been shown in block diagram form rather than in detail. Some portions of the detailed descriptions provided herein may be presented in terms of instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities.

Unless specifically stated otherwise as apparent from the foregoing discussion, it is appreciated that, throughout the foregoing description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is worthy to note that any reference to “one aspect,” “an aspect,” “one embodiment,” or “an embodiment” means that a particular feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular features, structures or characteristics may be combined in any suitable manner in one or more aspects.

Some aspects may be described in accordance with the expression “coupled” and “connected” along with their derivatives. It should be understood that these terms are not intended as synonyms for each other. For example, some aspects may be described using the term “connected” to indicate that two or more elements are in direct physical or electrical contact with each other. In another example, some aspects may be described using the term “coupled” to indicate that two or more elements are in direct physical or electrical contact. The term “coupled,” however, also may mean that two or more elements are not in direct contact with each other, but yet still co-operate or interact with each other.

It is worthy to note that any reference to “one aspect,” “an aspect,” “one embodiment,” or “an embodiment” means that a particular feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular features, structures or characteristics may be combined in any suitable manner in one or more aspects.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

All of the above-mentioned U.S. patents, U.S. patent application publications, U.S. patent applications, foreign patents, foreign patent applications, non-patent publications referred to in this specification and/or listed in any Application Data Sheet, or any other disclosure material are incorporated herein by reference, to the extent not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

1. A communication system comprising:
a body-associated client device configured to receive information indicative of physical performance of a user wearing the body-associated client device in relation to an event and to transmit a communication based on the physiologic information to a crowd endorsement computer networking system.

2. The communication system of claim 1, comprising a broadcast node configured to transmit the communication to a subscriber node associated with the broadcast node, wherein the short-burst communication comprises information associated with the physiologic information.

3. The communication system of claim 2, wherein the broadcast node is another body-associated client device.

4. The communication system of claim 3, wherein the subscriber node associated with the broadcast node is selected from the group consisting essentially of a computer system, another body-associated client device, a desktop computer, a notebook computer, a laptop computer, a netbook, a tablet computer, an e-book reader, a GPS device, a camera, a personal digital assistant (PDA), a handheld electronic device, a cellular telephone, a smartphone, an electronic scoreboard, an electronic billboard, public or private electronic signage, a video screen, a television screen, and any combination thereof.

5. The communication system of claim 1, wherein the body-associated client device is configured to transmit the short-burst communication automatically upon the occurrence of an event and/or after a predetermined time interval associated with the user wearing the body-associated client device.

6. The communication system of claim 1, wherein the crowd endorsement networking computer system is configured to employ the information received from the user to match a sponsor with the user.

7. The communication system of claim 1, wherein the body-associated client device is configured to transmit the short-burst communication based on at least one of physiologic or ingestion information received from an ingestible event marker swallowed by the user wearing the body-associated client device.

8. The communication system of claim 1, wherein the body-associated client device is configured to broadcast the short-burst messages from a broadcast node to a subscriber node associated with the broadcast node.

9. The communication system of claim 1, wherein the short-burst communication comprises information already stored at least in one of the body-associated device or in any other body-associated devices.

10. A crowd endorsement computer system comprising:
a network addressable computing system configured to host a crowd endorsement system, the computing system configured to receive information received from a body-associated client device, the information being associated with a user wearing the body-associated client device during an event, the computing system comprising:
a processor coupled to a memory, the memory comprising machine executable instructions that when executed by the processor cause the processor to:
receive communications from at least one body-associated client device, the communication including information identifying the user associated with the body-associated client device, the information being obtained from the user by way of electrodes electrically coupled to a body of the user and configured to detect both physiologic information and ingestion information associated with the user, the ingestible information being generated by an ingestible event marker ingested by the user;
associate the body-associated client device with one or more user sponsor accounts associated with the crowd endorsement computer system; and
identify a sponsor for the user associated with the body-associated client device based on the information received from the body-associated client device.

11. The crowd endorsement computer system of claim 10, wherein the network addressable computing system is configured to:
establish a crowd endorsement community available for funding the user;
request endorsement from the sponsor by the user;
post goals and aspirations by the user; and
endorse the user.

12. The crowd endorsement computer system of claim 11, wherein the user is an athlete.

13. The crowd endorsement computer system of claim 10, wherein the network addressable computing system is configured to enable the user to update a blog.

14. The crowd endorsement computer system of claim 10, wherein the network addressable computing system is configured to enable the user to update progress, training, and/or physiologic data.

15. The crowd endorsement computer system of claim 10, wherein the network addressable computing system is configured to transmit information from the sponsor to the body-associated client device worn by the user during the event.

16. The crowd endorsement computer system of claim 15, wherein the network addressable computing system is configured to transmit endorsement information to the user based on the user's success at the event.

17. A method for crowd endorsement in a network addressable computing system environment configured to host a crowd endorsement system, the computing system configured to receive information received from a body-associated client device, the information being associated with a user wearing the body-associated client device during an event, the computing system comprising a processor coupled to a memory, the memory comprising machine executable instructions that are executable by the processor for:
receiving communications from at least one body-associated client device, the communication including information identifying the user associated with the body-associated client device, the information being obtained from the user by way of electrodes electrically coupled to a body of the user and configured to detect both physiologic information and ingestion information associated with the user, the ingestible information being generated by an ingestible event marker ingested by the user;
associating the body-associated client device with one or more user sponsor accounts associated with the crowd endorsement computer system; and
identifying a sponsor for the user associated with the body-associated client device based on the information received from the body-associated client device.

18. The method of claim 17, comprising:
establishing a crowd endorsement community available for funding the user;
requesting endorsement from the sponsor by the user;
posting goals and aspirations by the user; and
endorsing the user.

19. The method of claim 17, comprising enabling the user to update a blog, progress, training, and/or physiologic data.

20. The method of claim 17, comprising transmitting information from the sponsor to the body-associated client device worn by the user during the event, wherein the information comprises endorsement information to the user based on the user's success at the event.
